(19) United States
(12) Patent Application Publication
(10) Pub. No.: US 2024/0037439 A1
(43) Pub. Date: Feb. 1, 2024

(54) QUANTUM SYSTEM SELECTION VIA COUPLING MAP COMPARISON

(71) Applicant: International Business Machines Corporation, Armonk, NY (US)

(72) Inventors: John S. Werner, Fishkill, NY (US); Vladimir Rastunkov, Mundelein, IL (US); Frederik Frank Flöther, Schlieren (CH)

(21) Appl. No.: 17/815,450

(22) Filed: Jul. 27, 2022

(51) Int. Cl. G06N 10/60

(52) U.S. Cl. CPC G06N 10/60

(57) ABSTRACT

Systems/techniques that facilitate quantum system selection via coupling map comparison are provided. In various embodiments, a system can access a quantum machine learning (QML) model. In various aspects, the system can identify, from a set of quantum computing systems, a quantum computing system for the QML model, based on a comparison between a first coupling map of the quantum computing system and a second coupling map on which the QML model was trained. If the second coupling map topologically matches the first coupling map or topologically matches a subgraph of the first coupling map, the system can execute the QML model on the quantum computing system. Otherwise, the system can adjust the QML model and can accordingly execute the adjusted QML model on the quantum computing system.

### BACKGROUND

The subject disclosure relates to quantum systems, and more specifically to facilitating quantum system selection via coupling map comparison.

When given a quantum machine learning (“QML”) model that has already been trained, it can often be desired to select on which, from a group of quantum computing systems, the given QML model should be executed. Unfortunately, existing techniques for facilitating such selection utilize overly-simplistic heuristics that often cause an inappropriate quantum computing system to be selected.

Accordingly, systems and/or techniques that can address one or more of these technical problems can be desirable.

### SUMMARY

The following presents a summary to provide a basic understanding of one or more embodiments described herein. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products that can facilitate quantum system selection via coupling map comparison are described.

According to various embodiments, a system can be provided. In various aspects, the system can comprise at least one processor that can execute computer-executable components stored in at least one non-transitory computer-readable memory. In various instances, the computer-executable components can comprise an access component that can access a quantum machine learning model. In various cases, the computer-executable components can further comprise a selection component that can identify, from a set of quantum computing systems, a quantum computing system for the quantum machine learning model, based on a comparison between a first coupling map of the quantum computing system and a second coupling map on which the quantum machine learning model was trained. In various aspects, the computer-executable components can further comprise an execution component that can execute the quantum machine learning model or an adjusted version of the quantum machine learning model on the quantum computing system. Because such system can perform quantum system selection by comparing coupling maps of candidate quantum computers to the coupling map on which the quantum machine learning model was trained, such system can exhibit a significantly increased likelihood of making an appropriate quantum system selection, as opposed to techniques that rely upon overly-simplistic heuristics such as comparison of mere number of qubits.

In one or more other embodiments of such system, which may be used in combination with any of the previous embodiments of such system mentioned in the Summary, the first coupling map can be a graph whose nodes respectively represent qubits of the quantum computing system and whose edges respectively represent qubit-to-qubit connections of the quantum computing system. Likewise, in any suitable embodiments of such system, the second coupling map can be a graph whose nodes respectively represent qubits of another quantum computing system on which the quantum machine learning model was trained and whose edges respectively represent qubit-to-qubit connections of the another quantum computing system on which the quantum machine learning model was trained. Moreover, in any suitable embodiments of such system, the computer-executable components can further comprise a map component that can compare the first coupling map to the second coupling map by computing a subgraph matching metric. Furthermore, in any suitable embodiments of such system, the subgraph matching metric can be a Gromov-Hausdorff distance between the first coupling map and the second coupling map, and/or can be a Manhattan distance between the first coupling map and the second coupling map. Again, by performing quantum system selection via coupling map comparison (e.g., specifically via subgraph matching, which can be facilitated via Gromov-Hausdorff distance and/or Manhattan distance calculation) instead of via an overly-simplistic heuristic such as comparison of mere number of qubits, such system can be more likely to select an appropriate quantum computer for the quantum machine learning model.

In one or more other embodiments of such system, which may be used in combination with any of the previous embodiments of such system mentioned in the Summary, the second coupling map can topologically match the first coupling map or can topologically match a subgraph of the first coupling map, and the execution component can execute the quantum machine learning model on the quantum computing system. After all, when the second coupling map topologically matches the first coupling map or topologically matches a subgraph of the first coupling map, it can be concluded that the quantum computing system is an appropriate choice for the quantum machine learning model (e.g., it can be concluded that the quantum machine learning model can be executed on the quantum computing system).

In one or more other embodiments of such system, which may be used in combination with any of the previous embodiments of such system mentioned in the Summary, the second coupling map can fail to topologically match the first coupling map and can fail to topologically match any subgraph of the first coupling map. In such case, the access component can access a set of variable importance scores associated with the quantum machine learning model, and the computer-executable components can further comprise an adjustment component that can adjust, based on the set of variable importance scores, the quantum machine learning model, thereby yielding the adjusted version of the quantum machine learning model. In any suitable embodiments of such system, the adjustment component can adjust the quantum machine learning model by iteratively removing, in order of increasing variable importance score, at least one logical qubit or at least one quantum gate from the quantum machine learning model. In any of these cases, the execution component can execute the adjusted version of the quantum machine learning model on the quantum computing system. After all, when the second coupling map fails to topologically match the first coupling map and fails to topologically match any/every subgraph of the first coupling map, it can be concluded that the quantum computing system is not an appropriate choice for the quantum machine learning model (e.g., it can be concluded that the quantum machine learning model cannot be executed on the quantum computing system). Note that the system can draw such conclusion even when the first coupling map possesses at least as many qubits as the second coupling map. In contrast, an overly-simplistic heuristic technique, such as comparison of mere number of qubits, would incorrectly conclude in such case that the quantum computing system is appropriate for the quantum machine learning model (e.g., would incorrectly conclude that the quantum machine learning model can be executed on the quantum computing system).

In one or more other embodiments of such system, which may be used in combination with any of the previous embodiments of such system mentioned in the Summary, the adjustment component can determine, by one or more test runs, an accuracy level of the adjusted version of the quantum machine learning model. In various cases, computation of such accuracy level can help to show how much drop in performance of the quantum machine learning model is being experienced in exchange for executing the quantum machine learning model without delay (e.g., without waiting for a quantum computing system that is appropriate for the unmodified version of the quantum machine learning model to become available).

In one or more other embodiments of such system, which may be used in combination with any of the previous embodiments of such system mentioned in the Summary, the map component and the adjustment component can prioritize analysis of the set of quantum computing systems according to system availability, qubit count, noise levels, or coherence times. In various cases, such embodiments can help to ensure that the most promising quantum computing systems can be analyzed (e.g., via coupling map comparison as described herein) first and/or that the least promising quantum computing systems can be analyzed last.

In various aspects, any combination and/or combinations of any embodiments of the above-described system can be implemented.

According to various embodiments, a computer-implemented method can be provided. In various aspects, the computer-implemented method can comprise accessing, by a device operatively coupled to at least one processor, a quantum machine learning model. In various instances, the computer-implemented method can further comprise identifying, by the device and from a set of quantum computing systems, a quantum computing system for the quantum machine learning model, based on a comparison between a first coupling map of the quantum computing system and a second coupling map on which the quantum machine learning model was trained. In various cases, the computer-implemented method can further comprise executing, by the device, the quantum machine learning model or an adjusted version of the quantum machine learning model on the quantum computing system. Because such computer-implemented method can perform quantum system selection by comparing coupling maps of candidate quantum computers to the coupling map on which the quantum machine learning model was trained, such computer-implemented method can exhibit a significantly increased likelihood of making an appropriate quantum system selection, as opposed to techniques that rely upon overly-simplistic heuristics such as comparison of mere number of qubits.

In one or more other embodiments of such computer-implemented method, which may be used in combination with any of the previous embodiments of such computer-implemented method mentioned in the Summary, the first coupling map can be a graph whose nodes respectively represent qubits of the quantum computing system and whose edges respectively represent qubit-to-qubit connections of the quantum computing system. Likewise, in any suitable embodiments of such computer-implemented method, the second coupling map can be a graph whose nodes respectively represent qubits of another quantum computing system on which the quantum machine learning model was trained and whose edges respectively represent qubit-to-qubit connections of the another quantum computing system on which the quantum machine learning model was trained. Moreover, in any suitable embodiments, such computer-implemented method can further comprise facilitating, by the device, the comparison between the first coupling map and the second coupling map by computing a subgraph matching metric. Furthermore, in any suitable embodiments of such computer-implemented method, the subgraph matching metric can be a Gromov-Hausdorff distance between the first coupling map and the second coupling map, and/or can be a Manhattan distance between the first coupling map and the second coupling map. Again, by performing quantum system selection via coupling map comparison (e.g., specifically via subgraph matching, which can be facilitated via Gromov-Hausdorff distance and/or Manhattan distance calculation) instead of via an overly-simplistic heuristic such as comparison of mere number of qubits, such computer-implemented method can be more likely to select an appropriate quantum computer for the quantum machine learning model.

In one or more other embodiments of such computer-implemented method, which may be used in combination with any of the previous embodiments of such computer-implemented method mentioned in the Summary, the second coupling map can topologically match the first coupling map or can topologically match a subgraph of the first coupling map, and the computer-implemented method can further comprise executing, by the device, the quantum machine learning model on the quantum computing system. After all, when the second coupling map topologically matches the first coupling map or topologically matches a subgraph of the first coupling map, it can be concluded that the quantum computing system is an appropriate choice for the quantum machine learning model (e.g., it can be concluded that the quantum machine learning model can be executed on the quantum computing system).

In one or more other embodiments of such computer-implemented method, which may be used in combination with any of the previous embodiments of such computer-implemented method mentioned in the Summary, the second coupling map can fail to topologically match the first coupling map and can fail to topologically match any subgraph of the first coupling map. In such case, the computer-implemented method can further comprise: accessing, by the device, a set of variable importance scores associated with the quantum machine learning model; and adjusting, by the device and based on the set of variable importance scores, the quantum machine learning model, thereby yielding the adjusted version of the quantum machine learning model. In any suitable embodiments of such computer-implemented method, the adjusting the quantum machine learning model can include iteratively removing, by the device and in order of increasing variable importance score, at least one logical qubit or at least one quantum gate from the quantum machine learning model. In any of these cases, the device can execute the adjusted version of the quantum machine learning model on the quantum computing system. After all, when the second coupling map fails to topologically match the first coupling map and fails to topologically match any/every subgraph of the first coupling map, it can be concluded that the quantum computing system is not an appropriate choice for the quantum machine learning model (e.g., it can be concluded that the quantum machine learning model cannot be executed on the quantum computing system). Note that the computer-implemented method can draw such conclusion even when the first coupling map possesses at least as many qubits as the second coupling map. In contrast, an overly-simplistic heuristic technique, such as comparison of mere number of qubits, would incorrectly conclude in such case that the quantum computing system is appropriate for the quantum machine learning model (e.g., would incorrectly conclude that the quantum machine learning model can be executed on the quantum computing system).

In one or more other embodiments of such computer-implemented method, which may be used in combination with any of the previous embodiments of such computer-implemented method mentioned in the Summary, the computer-implemented method can further comprise determining, by the device and via one or more test runs, an accuracy level of the adjusted version of the quantum machine learning model. In various cases, computation of such accuracy level can help to show how much drop in performance of the quantum machine learning model is being experienced in exchange for executing the quantum machine learning model without delay (e.g., without waiting for a quantum computing system that is appropriate for the unmodified version of the quantum machine learning model to become available).

In one or more other embodiments of such computer-implemented method, which may be used in combination with any of the previous embodiments of such computer-implemented method mentioned in the Summary, the device can prioritize analysis of the set of quantum computing systems according to system availability, qubit count, noise levels, or coherence times. In various cases, such embodiments can help to ensure that the most promising quantum computing systems can be analyzed (e.g., via coupling map comparison) first and/or that the least promising quantum computing systems can be analyzed last.

In various aspects, any combination and/or combinations of any embodiments of the above-described computer-implemented method can be implemented.

According to various embodiments, a computer program product for facilitating quantum system selection via coupling map comparison can be provided. In various aspects, the computer program product can comprise at least one non-transitory computer-readable memory having program instructions embodied therewith, and the program instructions can be executable by at least one processor to cause the at least one processor to perform various operations. In various instances, such operations can comprise accessing a quantum machine learning model and a set of variable importance scores associated with the quantum machine learning model. In various cases, such operations can further comprise identifying, from a set of quantum computing systems, a quantum computing system for the quantum machine learning model, wherein a first coupling map of the quantum computing system does not topologically match a second coupling map on which the quantum machine learning model was trained, and wherein no subgraph of the first coupling map topologically matches the second coupling map on which the quantum machine learning model was trained. In various aspects, such operations can even further comprise adjusting, based on the set of variable importance scores, the quantum machine learning model, thereby yielding an adjusted version of the quantum machine learning model. In various instances, such operations can yet further comprise executing the adjusted version of the quantum machine learning model on the quantum computing system. Because such computer program product can perform quantum system selection by comparing coupling maps of candidate quantum computers to the coupling map on which the quantum machine learning model was trained, such computer program product can exhibit a significantly increased likelihood of making an appropriate quantum system selection, as opposed to techniques that rely upon overly-simplistic heuristics such as comparison of mere number of qubits.

In one or more other embodiments of such computer program product, which may be used in combination with any of the previous embodiments of such computer program product mentioned in the Summary, the at least one processor can adjust the quantum machine learning model by iteratively removing, in order of increasing variable importance score, at least one logical qubit or at least one quantum gate from the quantum machine learning model. Moreover, in any suitable embodiments of such computer program product, the at least one processor can adjust the quantum machine learning model by iteratively removing, in random order, at least one logical qubit or at least one quantum gate from the quantum machine learning model. Furthermore, in any suitable embodiments of such computer program product, the set of variable importance scores can be based on univariate Fisher scores of the quantum machine learning model or local scope Shapley values of the quantum machine learning model. In various cases, such embodiments can help to address situations in which no currently-available quantum computer is appropriate for the quantum machine learning model. In other words, by adjusting/modifying the quantum machine learning model and executing the adjusted/modified version of the quantum machine learning model on a currently-available quantum computer, at least some execution results can be provided/obtained, notwithstanding that no currently-available quantum computer might be appropriate for the unmodified/unadjusted version of the quantum machine learning model.

In various aspects, any combination and/or combinations of any embodiments of the above-described computer program product can be implemented.

### DESCRIPTION OF THE DRAWINGS

FIG. 1 illustrates a block diagram of an example, non-limiting system that facilitates quantum system selection via coupling map comparison in accordance with one or more embodiments described herein.

FIG. 2 illustrates an example, non-limiting block diagram of a quantum computing system vault in accordance with one or more embodiments described herein.

FIG. 3 illustrates an example, non-limiting block diagram of a quantum machine learning model and/or of variable importance scores in accordance with one or more embodiments described herein.

FIG. 4 illustrates an example, non-limiting block diagram of test data in accordance with one or more embodiments described herein.

FIG. 5 illustrates a block diagram of an example, non-limiting system including a set of coupling map similarity scores that facilitates quantum system selection via coupling map comparison in accordance with one or more embodiments described herein.

FIGS. 6-7 illustrate example, non-limiting block diagrams showing how a set of coupling map similarity scores can be generated in accordance with one or more embodiments described herein.

FIG. 8 illustrates a block diagram of an example, non-limiting system including a set of adjusted quantum machine learning models and/or a set of accuracy levels that facilitates quantum system selection via coupling map comparison in accordance with one or more embodiments described herein.

FIG. 9 illustrates an example, non-limiting block diagram showing how a set of adjusted quantum machine learning models can be generated in accordance with one or more embodiments described herein.

FIG. 10 illustrates an example, non-limiting block diagram showing how a set of accuracy levels can be generated in accordance with one or more embodiments described herein.

FIG. 11 illustrates a block diagram of an example, non-limiting system including a selected quantum computing system that facilitates quantum system selection via coupling map comparison in accordance with one or more embodiments described herein.

FIGS. 12-15 illustrate flow diagrams of example, non-limiting computer-implemented methods that facilitate quantum system selection via coupling map comparison in accordance with one or more embodiments described herein.

FIGS. 16-18 illustrate block diagrams of example, non-limiting experimental results in accordance with one or more embodiments described herein.

FIG. 19 illustrates a flow diagram of an example, non-limiting computer-implemented method that facilitates quantum system selection via coupling map comparison in accordance with one or more embodiments described herein.

FIG. 20 illustrates a block diagram of an example, non-limiting operating environment in which one or more embodiments described herein can be facilitated.

FIG. 21 illustrates an example, non-limiting cloud computing environment in accordance with one or more embodiments described herein.

FIG. 22 illustrates example, non-limiting abstraction model layers in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A quantum computing system can be any suitable device that utilizes a qubit lattice (e.g., a plurality of superconducting qubits fabricated on one or more quantum substrates and exhibiting any suitable connection topology) for information processing. A quantum circuit can be a sequence of parallel and/or series quantum gates that can be executed on a quantum computing system. A quantum gate can be a basic component of a quantum circuit that can change, alter, and/or otherwise affect the state of a qubit. As some non-limiting examples, a quantum gate can be any suitable single-qubit gate (e.g., Pauli-X gates, Pauli-Y gates, Pauli-Z gates, Phase gates, Rotation gates) and/or any suitable entangling/two-qubit gate (e.g., Controlled-Not gates, Controlled-Phase gates). A quantum machine learning (“QML”) model can be a parametrized quantum circuit whose internal parameters (e.g., magnitudes and/or directions of rotation implemented by Rotation gates in the QML model) are iteratively learned through training.

When given a QML model that has already been trained and which is desired to be deployed/implemented in the field, it can often be desired to select on which, from a group of quantum computing systems, the given QML model should be executed. Such selection can be desirable for various reasons. First, executing the given QML model on a quantum computing system that is different from that on which the given QML model was trained can cause the given QML model to yield suboptimal results. Indeed, in some cases, the given QML model cannot be executed at all on a quantum computing system that is too different from the quantum computing system that trained the given QML model. Second, new quantum computing architectures are continually being introduced/developed due to ongoing research initiatives, while existing quantum computing architectures are continually being temporarily occupied/utilized by consumers, temporarily retired for repair/maintenance (e.g., due to qubit burnout, due to qubit malfunction), and/or permanently decommissioned (e.g., due to obsolescence). Additionally, running the given QML model on the quantum computing system that was originally used in training may not be the preferred operation in instances where intervening events (e.g., qubit burnout, change in qubit error rate) may have an impact on performance. In other words, the quantum computing system on which the given QML model was trained might not be available in the particular field/context where it is desired to deploy/implement the given QML model. Accordingly, it can be desirable to select, determine, and/or otherwise identify which of a set of quantum computing systems is appropriate for the given QML model. As the term “appropriate” is used herein, a quantum computing system can be considered as “appropriate” for a given QML model, when the given QML model is able to be executed on that quantum computing system without any suitable threshold level of accuracy, without modification, without change, and/or otherwise as originally trained.

Unfortunately, existing techniques for facilitating such selection, determination, and/or identification utilize overly-simplistic heuristics that often cause an inappropriate quantum computing system to be selected. For example, many existing techniques consider only qubit count. That is, when determining whether a particular quantum computing system is appropriate for the given QML model, such existing techniques compare the number of qubits contained within that particular quantum computing system to the number of qubits utilized by the given QML model (e.g., utilized by the given QML model for information processing and/or error mitigation purposes). If the number of qubits contained within that particular quantum computing system is greater than or equal to the number of qubits utilized by the given QML model, such existing techniques will conclude that the particular quantum computing system is appropriate for the given QML model. However, as the inventors of various embodiments described herein realized, such reliance on qubit count is highly vulnerable to inaccuracy.

Therefore, systems and/or techniques that can address one or more of these technical problems can be desirable.

Various embodiments described herein can address one or more of these technical problems. Specifically, various embodiments described herein can provide systems and/or techniques that can facilitate quantum system selection via coupling map comparison. As mentioned above, existing techniques for facilitating quantum system selection rely upon overly-simplistic heuristics, such as comparison of total number of qubits. In particular, when given a quantum computing system and a QML model, such existing techniques determine that the quantum computing system is appropriate for the QML model (e.g., conclude that the QML model can be executed with sufficient accuracy on the quantum computing system), when the total number of qubits contained within the quantum computing system is greater than or equal to the total number of qubits utilized by the QML model. However, the present inventors realized that such existing techniques often select inappropriate/inapt quantum computing systems (e.g., often select quantum computing systems on which the QML model is not executable with sufficient accuracy), because such existing techniques ignore qubit connection topology. Indeed, as the present inventors realized, two quantum computing systems can have different connection topologies, meaning that those two quantum computing systems cannot necessarily support the same quantum circuits as each other, despite having the same total number of qubits as each other.

As a non-limiting example, consider a quantum computer A that has three qubits, where the first qubit of the quantum computer A is coupled to the second qubit of the quantum computer A, and where the second qubit of the quantum computer A is coupled to the third qubit of the quantum computer A. Furthermore, consider a quantum computer B that also has three qubits. However, suppose that the first qubit of the quantum computer B is coupled to the second qubit of the quantum computer B, that the second qubit of the quantum computer B is coupled to the third qubit of the quantum computer B, and that the third qubit of the quantum computer B is coupled to the first qubit of the quantum computer B. In such case, both the quantum computer A and the quantum computer B can support entanglement between their respective first and second qubits, and both the quantum computer A and the quantum computer B can support entanglement between their respective second and third qubits. However, the quantum computer B can further support entanglement between its first and third qubits, whereas the quantum computer A cannot support entanglement between its first and third qubits. Accordingly, a three-qubit QML model that has been trained on the quantum computer B might not be executable on the quantum computer A, notwithstanding that the quantum computer A and the quantum computer B have the same total number of qubits as each other (e.g., notwithstanding that the total number of qubits contained within the quantum computer A is greater than or equal to the total number of qubits utilized by the QML model). Stated differently, even though both the quantum computer A and the quantum computer B can each have three qubits, and even though the QML model can utilize three qubits, the QML model can include entangling gates that are implementable on the quantum computer B but that are not implementable on the quantum computer A.

Instead of such overly-simplistic heuristics that consider only total number of qubits, the present inventors devised an improved technique for selecting quantum computing systems when given a pre-trained QML model, where such improved technique leverages coupling map (e.g., connection topology) comparison. More specifically, when given a particular QML model and a particular quantum computing system, the present inventors realized that whether or not the particular QML model is executable on the particular quantum computing system can accurately/precisely be determined by comparing the coupling map (e.g., connection topology) of the particular quantum computing system to the coupling map (e.g., connection topology) of the quantum computing system on which the particular QML model was trained. If the coupling map, or any subgraph thereof, of the particular quantum computing system topologically matches (e.g., has the same qubit connectivity as) the coupling map of the quantum computing system on which the particular QML model was trained, it can be inferred that the particular QML model is executable on the particular quantum computing system. In contrast, if the coupling map, and every subgraph thereof, of the particular quantum computing system fails to topologically match (e.g., does not have the same qubit connectivity as) the coupling map of the quantum computing system on which the particular QML model was trained, it can instead be inferred that the particular QML model is not accurately executable on the particular quantum computing system. In such latter case, the particular QML model can, in various aspects, be iteratively relaxed/adjusted until it is executable on the particular quantum computing system, as described further herein.

Various embodiments described herein can be considered as a computerized tool (e.g., any suitable combination of computer-executable hardware and/or computer-executable software) that can electronically facilitate quantum system selection via coupling map comparison. In various aspects, such a computerized tool can comprise an access component, a map component, an adjustment component, a selection component, and/or an execution component.

In various embodiments, there can be a quantum computing system vault. In various aspects, the quantum computing system vault can be any suitable centralized and/or decentralized collection of tangible, hardware-based quantum computing systems, each of which can have and/or otherwise be associated with a corresponding coupling map. In various other aspects, the quantum computing system vault can contain any suitable centralized and/or decentralized database that stores electronic information (e.g., metadata) pertaining to various quantum computing systems. In any case, and as mentioned above, a quantum computing system can be any suitable device that utilizes any suitable number of any suitable types of qubits (e.g., superconducting qubits, such as transmon qubits) for information processing.

In various aspects, each quantum computing system in the quantum computing system vault can have and/or otherwise be associated with a corresponding coupling map. In various instances, a coupling map that corresponds to a quantum computing system can be a graph data structure (e.g., having vertices and edges) that indicates and/or otherwise represents how the qubits of the quantum computing system are collectively coupled to each other. That is, the coupling map can be considered as indicating and/or representing the connection topology of the quantum computing system. More specifically, the coupling map can include a plurality of vertices and/or a plurality of edges, where each unique vertex in the coupling map can represent and/or correspond to a unique qubit in the quantum computing system, where each unique edge in the coupling map can be between two vertices of the coupling map, and/or where each unique edge of the coupling map can represent and/or correspond to a unique qubit-to-qubit connection in the quantum computing system. In some cases, the coupling map can be unweighted. In other cases, however, the coupling map can be weighted by any suitable criteria pertaining to the quantum computing system. For example, vertices and/or edges of the coupling map can be weighted according to transition frequencies of the qubits and/or couplers in the quantum computing system. As some non-limiting examples, vertices and/or edges of the coupling map can be weighted according to: decoherence times of the qubits and/or couplers in the quantum computing system; relaxation times of the qubits and/or couplers in the quantum computing system; noise levels of the qubits and/or couplers in the quantum computing system; error rates of the qubits and/or couplers in the quantum computing system; fidelities of the qubits and/or couplers in the quantum computing system; and/or entanglement strengths of the qubits and/or couplers in the quantum computing system.

In various aspects, there can be a QML model that has already undergone training. In various instances, the QML model can include any suitable number of logical qubits and/or can further include any suitable number of any suitable types of quantum gates which can operate, in series and/or in parallel, on such logical qubits.

In various cases, the QML model can correspond to and/or otherwise be associated with a training coupling map. In various aspects, the training coupling map can be a graph data structure having a plurality of vertices and/or a plurality of edges, where each unique vertex in the training coupling map can represent and/or correspond to a unique qubit in the specific quantum computing system on which the QML model was trained, where each unique edge in the training coupling map can be between two vertices of the training coupling map, and/or where each unique edge in the training coupling map can represent and/or correspond to a unique qubit-to-qubit connection in the specific quantum computing system on which the QML model was trained. As above, the training coupling map can be unweighted in some cases, and/or can be weighted (e.g., according to transition frequencies, decoherence times, relaxation times, error rates, noise levels, fidelities, and/or entanglement strengths) in other cases.

In various instances, the QML model can further correspond to and/or otherwise be associated with a set of variable importance scores. In various cases, as mentioned above, the QML model can be considered as including a set of quantum gates that operate on a set of logical qubits. In various aspects, the set of variable importance scores can include a set of gate scores that respectively correspond to the set of quantum gates of the QML model, and/or can further include a set of qubit scores that respectively correspond to the set of logical qubits of the QML model. In various instances, each gate score can be a real-valued scalar whose magnitude indicates and/or represents a relative level of importance of a corresponding quantum gate with respect to the functionality of the QML model. Similarly, in various cases, each qubit score can be a real-valued scalar whose magnitude indicates and/or represents a relative level of importance of a corresponding logical qubit with respect to the functionality of the QML model. As a non-limiting example, a quantum gate that has a lower gate score can be considered as being less important to the functionality/operability of the QML model, whereas a quantum gate that has a higher gate score can be considered as being more important to the functionality/operability of the QML model. Likewise, as another non-limiting example, a logical qubit that has a lower qubit score can be considered as being less important to the functionality/operability of the QML model, whereas a logical qubit that has a higher qubit score can be considered as being more important to the functionality/operability of the QML model. In various cases, the set of variable importance scores can be equal to, generated from, derived from, and/or otherwise based on univariate Fisher scores of the QML model, local scope Shapley values of the QML model, and/or norms of the learnable parameters of the QML model with respect to the input variables of the QML model.

In various aspects, the QML model can further correspond to and/or otherwise be associated with test data. In various instances, the test data can include a set of input quantum states and/or a respectively corresponding set of output quantum states. In various cases, each input quantum state can be a vector having a dimensionality of 2^{g}, where g can be any suitable positive integer representing the number of logical qubits utilized by the QML model. In various aspects, each output quantum state can be a vector having a dimensionality of 2^{h}, where h can be any suitable positive integer such that h≤g. In various instances, the set of output quantum states can be considered as ground-truths that are known and/or otherwise deemed to respectively correspond to the set of input quantum states.

In various embodiments, the access component of the computerized tool can electronically access, via any suitable wired and/or wireless electronic connections, the quantum computing system vault. In various aspects, the access component can further access and/or otherwise receive, retrieve, and/or import from any suitable source the QML model, the training coupling map, the set of variable importance scores, and/or the test data. For instance, the access component can electronically retrieve and/or import the QML model, the training coupling map, the set of variable importance scores, and/or the test data from any suitable centralized and/or decentralized database (e.g., graph database, relational database, hybrid database), whether remote from and/or local to the access component. In various other instances, the access component can electronically retrieve and/or import the QML model, the training coupling map, the set of variable importance scores, and/or the test data from any other suitable computing device and/or computing devices. For example, a user-device, such as a laptop computer, a desktop computer, or a smart phone, can provide/transmit the QML model, the training coupling map, the set of variable importance scores, and/or the test data to the access component. In any case, the access component can electronically access the quantum computing system vault, the QML model, the training coupling map, the set of variable importance scores, and/or the test data, such that other components of the computerized tool can electronically interact with (e.g., read, write, edit, manipulate) the quantum computing system vault, the QML model, the training coupling map, the set of variable importance scores, and/or the test data.

In various embodiments, the map component of the computerized tool can electronically generate a set of coupling map similarity scores, based on comparing coupling maps from the quantum computing system vault to the training coupling map. In particular, for any given quantum computing system in the vault, the map component can compute a similarity score for that given quantum computing system. In various aspects, the similarity score can be a real-valued scalar whose magnitude describes, indicates, and/or otherwise conveys how similar and/or how dissimilar the particular coupling map of that given quantum computing system is to the training coupling map.

In various instances, because the particular coupling map of the given quantum computing system and the training coupling map can both be graphs, the map component can generate the similarity score by computing any suitable subgraph matching metric between the particular coupling map and the training coupling map. In various instances, a subgraph matching metric can be any suitable function and/or algorithm from graph theory that can take as input two graphs and that can produce as output a scalar whose value/magnitude can represent how far apart (e.g., how different) those two inputted graphs are. As a non-limiting example, a subgraph matching metric can be a Gromov-Hausdorff distance. As another non-limiting example, a subgraph matching metric can be a Manhattan distance. As yet another non-limiting example, a subgraph matching metric can be a graph edit distance. As even another non-limiting example, a subgraph matching metric can be a Min/Max similarity measure.

In any case, the map component can compute at least one subgraph matching metric between the particular coupling map of the given quantum computing system and the training coupling map, and the map component can calculate the similarity score based on such at least one subgraph matching metric. In some instances, the similarity score can be equal to a subgraph matching metric between the particular coupling map and the training coupling map. In such case, the degree of similarity between the particular coupling map and the training coupling map can decrease as the value/magnitude of the similarity score increases. In other instances, the similarity score can be any suitable mathematical function of one or more subgraph matching metrics between the particular coupling map and the training coupling map. For example, the similarity score can be based on a reciprocal of a subgraph matching metric, such that the degree of similarity between the particular coupling map and the training coupling map can increase as the value/magnitude of the similarity score increases. In any case, the similarity score can indicate how similar and/or how dissimilar the particular coupling map is as compared to the training coupling map.

In various aspects, there can be any suitable threshold similarity score that can denote and/or otherwise demarcate topological matching. As a non-limiting example, the threshold similarity score can correspond to a minimal and/or minimized subgraph matching metric (e.g., the threshold similarity score can be equal to whatever similarity score value indicates a Gromov-Hausdorff distance of zero, can be equal to whatever similarity score value indicates a Manhattan distance of zero, and/or can be equal to whatever similarity score value indicates a graph edit distance of zero). As another non-limiting example, the threshold similarity score can correspond to any non-minimal and/or non-minimized subgraph matching metric (e.g., the threshold similarity score can be equal to whatever similarity score value indicates any predetermined, non-zero Gromov-Hausdorff distance; can be equal to whatever similarity score value indicates any predetermined, non-zero Manhattan distance; and/or can be equal to whatever similarity score value indicates any predetermined, non-zero graph edit distance).

In any case, when the similarity score satisfies the threshold similarity score, the map component can conclude that: (i) the particular coupling map topologically matches the training coupling map; or (ii) at least one subgraph of the particular coupling map topologically matches the training coupling map. In contrast, when the similarity score fails to satisfy the threshold similarity score, the map component can conclude that: (iii) the particular coupling map does not topologically match the training coupling map; and (iv) no subgraph of the particular coupling map topologically matches the training coupling map.

Suppose that the threshold similarity score denotes a minimal/minimized subgraph matching metric. In such case, if the particular coupling map topologically matches the training coupling map, this can mean that the particular coupling map has the same/identical arrangements and/or properties of qubits and qubit-to-qubit connections as the training coupling map. Furthermore, in such case, if a subgraph of the particular coupling map topologically matches the training coupling map, this can mean that such subgraph has the same/identical arrangements and/or properties of qubits and qubit-to-qubit connections as the training coupling map (e.g., the particular coupling map can be considered as containing the training coupling map).

Suppose instead that the threshold similarity score denotes a non-minimal/non-minimized subgraph matching metric. In such case, if the particular coupling map topologically matches the training coupling map, this can mean that the particular coupling map has sufficiently similar, though not necessarily identical, arrangements and/or properties of qubits and qubit-to-qubit connections as the training coupling map. Moreover, in such case, if a subgraph of the particular coupling map topologically matches the training coupling map, this can mean that such subgraph has sufficiently similar, though not necessarily identical, arrangements and/or properties of qubits and qubit-to-qubit connections as the training coupling map.

In any case, when the similarity score of the particular coupling map satisfies the threshold similarity score (e.g., when the particular coupling map or a subgraph thereof topologically matches the training coupling map), the QML model can be considered as being executable on the given quantum computing system, without change, without modification, and/or otherwise as originally trained (e.g., the particular coupling map can be considered as being identical and/or sufficiently similar to the training coupling map).

Suppose again that the threshold similarity score denotes a minimal/minimized subgraph matching metric. In such case, if the particular coupling map does not topologically match the training coupling map, this can mean that the particular coupling map does not have the same/identical arrangements and/or properties of qubits and qubit-to-qubit connections as the training coupling map. Furthermore, in such case, if no subgraph of the particular coupling map topologically matches the training coupling map, this can mean that no subgraph of the particular coupling map has the same/identical arrangements and/or properties of qubits and qubit-to-qubit connections as the training coupling map.

Suppose instead that the threshold similarity score denotes a non-minimal/non-minimized subgraph matching metric. In such case, if the particular coupling map does not topologically match the training coupling map, this can mean that the particular coupling map does not have sufficiently similar arrangements and/or properties of qubits and qubit-to-qubit connections as the training coupling map. Moreover, in such case, if no subgraph of the particular coupling map topologically matches the training coupling map, this can mean that no subgraph has sufficiently similar arrangements and/or properties of qubits and qubit-to-qubit connections as the training coupling map.

In any case, when the similarity score of the particular coupling map fails to satisfy the threshold similarity score (e.g., when the particular coupling map and every subgraph thereof fails to topologically match the training coupling map), the QML model can be considered as not being executable on the given quantum computing system, without change, without modification, and/or otherwise as originally trained (e.g., the particular coupling map can be considered as being too different from the training coupling map).

In various aspects, the map component can compute a similarity score, as described above, for each coupling map, and thus for each quantum computing system, that is in the quantum computing system vault. In some instances, the map component can iterate through each of the coupling maps in the quantum computing system vault according to any suitable order of priority. For example, in some cases, the map component can iterate through the coupling maps of the quantum computing system vault in a random order. As another example, in some cases, the map component can iterate through the coupling maps of the quantum computing system vault in order of system availability (e.g., quantum computing systems in the vault that are currently occupied, that are currently unavailable, and/or that currently have longer queue times can be analyzed by the map component later, whereas quantum computing systems in the vault that are not currently occupied, that are currently available, and/or that currently have shorter queue times can be analyzed by the map component earlier). As yet another example, in some cases, the map component can iterate through the coupling maps of the quantum computing system vault in order of qubit count (e.g., quantum computing systems in the vault that have higher numbers of qubits can be analyzed earlier by the map component, whereas quantum computing systems in the vault that have lower numbers of qubits can be analyzed later by the map component). As even another example, in some cases, the map component can iterate through the coupling maps of the quantum computing system vault in order of noise levels, error rates, and/or coherence times (e.g., quantum computing systems in the vault that have higher noise levels, higher error rates, and/or lower coherence times can be analyzed later by the map component, whereas quantum computing systems in the vault that have lower noise levels, lower error rates, and/or higher coherence times can be analyzed earlier by the map component).

In various embodiments, if any quantum computing system in the vault corresponds to a similarity score that satisfies the threshold similarity score (e.g., if any quantum computing system has a coupling map which topologically matches, or which has a subgraph that topologically matches, the training coupling map), then the selection component of the computerized tool can electronically select that quantum computing system as being appropriate for the QML model. Indeed, such quantum computing system can be guaranteed to be able to support all the quantum gates utilized by the QML model. If more than one such quantum computing system exists, then the selection component can select from among such more than one quantum computing systems according to any suitable order of priority (e.g., can select whichever of such quantum computing systems is available and/or has the lowest queue time, can select whichever of such quantum computing systems has the longest coherence times and/or the smallest noise/error levels, can select whichever of such quantum computing systems is associated with a lowest monetary price).

In such case, the execution component of the computerized tool can electronically generate, transmit to any suitable computing device, and/or visually display/render on any suitable computer screen an electronic message, where the electronic message can indicate that the selected quantum computing system is appropriate for the QML model. In some instances, the access component can further access a user-provided quantum state initialization, and the execution component can: initialize the selected quantum computing system with the user-provided quantum state initialization; execute the QML model on the initialized selected quantum computing system, thereby yielding a resultant quantum state; and/or display on any suitable computer screen and/or transmit to any suitable computing device the resultant quantum state.

In various embodiments, on the other hand, if no quantum computing system in the vault corresponds to a similarity score that satisfies the threshold similarity score (e.g., if no quantum computing system has a coupling map which topologically matches, or which has a subgraph that topologically matches, the training coupling map), then the adjustment component of the computerized tool can electronically generate a set of adjusted versions of the QML model. Indeed, in such case, none of the quantum computing systems in the vault can be able to support all the quantum gates utilized by the QML model. Accordingly, for each given quantum computing system in the vault, the adjustment component can generate one or more adjusted versions of the QML model that are executable on the given quantum computing system. In other words, the QML model can be adjusted, so that the given quantum computing system can support all the logical qubits and/or all the quantum gates utilized by such one or more adjusted versions of the QML model.

In various instances, as described herein, the adjustment component can generate an adjusted version of the QML model by creating a copy of the QML model and by iteratively removing and/or replacing, in order of increasing variable importance score and/or in random order, logical qubits and/or quantum gates from the copy of the QML model.

For example, suppose that the QML model has a total of a quantum gates that collectively operate on a total of b logical qubits, for any suitable positive integers a and b. In such case, the set of variable importance scores can include a total of a gate scores that respectively correspond (e.g., in one-to-one fashion) to the a quantum gates of the QML model, and can further include a total of b qubit scores that respectively correspond (e.g., in one-to-one fashion) to the b logical qubits of the QML model.

In various aspects, for any particular quantum computing system in the vault, the adjustment component can copy/duplicate the QML model and can remove/delete from such copy/duplicate whichever of the a quantum gates has a lowest/smallest gate score. After such removal, that now-modified copy/duplicate can have a total of a−1 quantum gates (e.g., where a−1>0) instead of a quantum gates.

In various instances, the adjustment component can check whether or not that now-modified copy/duplicate is executable on the particular quantum computing system. In other words, the adjustment component can check whether or not all of the remaining quantum gates in that copy/duplicate can be supported/implemented on the particular quantum computing system.

As a non-limiting example, the adjustment component can facilitate such check by attempting to execute the now-modified copy/duplicate on the particular quantum computing system. If such attempted execution is unsuccessful (e.g., if the particular quantum computing system returns one or more compilation errors and/or one or more runtime errors in response to such attempted execution), the adjustment component can conclude that the now-modified copy/duplicate is not executable on the particular quantum computing system. In contrast, if such attempted execution is successful (e.g., if the particular quantum computing system does not return one or more compilation errors and/or one or more runtime errors in response to such attempted execution), the adjustment component can instead conclude that the now-modified copy/duplicate is executable on the particular quantum computing system.

As another non-limiting example, the adjustment component can facilitate such check by: commensurately modifying/adjusting the training coupling map; and computing a new similarity score between the now-modified training coupling map and the coupling map of the particular quantum computing system.

For instance, as mentioned above, the adjustment component can create the now-modified copy/duplicate of the QML model by removing the lowest-scoring quantum gate. Suppose that such lowest-scoring quantum gate is a single-qubit gate that operates on a specific qubit within the training coupling map. It can be the case that no remaining quantum gates in the now-modified copy/duplicate operate on that specific qubit. In other words, removal of the lowest-scoring quantum gate can render that specific qubit unused by the now-modified copy/duplicate of the QML model. Accordingly, in various aspects, the adjustment component can remove that specific qubit from the training coupling map, thereby yielding a modified training coupling map.

As another example, suppose that the lowest-scoring quantum gate is instead an entangling gate that operates on two specific qubits that are coupled together by a specific qubit-to-qubit connection within the training coupling map. After the adjustment component removes such lowest-scoring quantum gate from the QML model, it can be the case that no remaining quantum gates in the now-modified copy/duplicate utilize that specific qubit-to-qubit connection. That is, removal of the lowest-scoring quantum gate can render that specific qubit-to-qubit connection unused by the now-modified copy/duplicate of the QML model. Accordingly, in various aspects, the adjustment component can remove that specific qubit-to-qubit connection from the training coupling map, thereby yielding a modified training coupling map.

In any of such cases, the adjustment component can generate a modified training coupling map (e.g., by removing qubits and/or qubit-to-qubit connections that are no longer used by the now-modified copy/duplicate of the QML model), and the map component can compute a new similarity score, as described above, between that modified training coupling map and the coupling map of the particular quantum computing system. If such new similarity score satisfies the threshold similarity score, then the adjustment component can conclude that the now-modified copy/duplicate of the QML model is executable on the particular quantum computing system. In contrast, if such new similarity score fails to satisfy the threshold similarity score, then the adjustment component can conclude that the now-modified copy/duplicate of the QML model is not yet executable on the particular quantum computing device.

In any case, the adjustment component can check whether or not the now-modified copy/duplicate of the QML model is executable on the particular quantum computing system. If the now-modified copy/duplicate is not yet executable on the particular quantum computing system, the adjustment component can remove/delete from the now-modified copy/duplicate whichever of the remaining a−1 quantum gates now has a lowest/smallest gate score, thereby causing the now-modified copy/duplicate to have a−2 quantum gates (e.g., where a−2>0).

In this way, the adjustment component can generate an adjusted version of the QML model that corresponds to the particular quantum computing system by: replicating the QML model; and iteratively eliminating/discarding quantum gates from the replica in order of gate score, until whatever remains of that replica is executable on the particular quantum computing system.

As another example, suppose again that the QML model has a total of a quantum gates that collectively operate on a total of b logical qubits, for any suitable positive integers a and b. As mentioned above, the set of variable importance scores can thus include a total of a gate scores that respectively correspond (e.g., in one-to-one fashion) to the a quantum gates of the QML model, and can further include a total of b qubit scores that respectively correspond (e.g., in one-to-one fashion) to the b logical qubits of the QML model.

In various aspects, for any specific quantum computing system in the vault, the adjustment component can copy/duplicate the QML model and can remove/delete from such copy/duplicate, whichever of the b logical qubits has a lowest/smallest qubit score. In other words, the adjustment component can remove/delete from such copy/duplicate every quantum gate that operates on the lowest-scoring logical qubit. After such removal of the lowest-scoring logical qubit (e.g., after such removal of all quantum gates that operate on the lowest-scoring logical qubit), that copy/duplicate can be considered as having fewer than a quantum gates and as having a total of b−1 logical qubits (e.g., where b−1>0) instead of b logical qubits.

In various instances, the adjustment component can check whether or not that now-modified copy/duplicate is executable on the specific quantum computing system. In other words, the adjustment component can check whether or not all of the remaining quantum gates and/or logical qubits in that now-modified copy/duplicate can be supported/implemented on the specific quantum computing system.

As mentioned above, the adjustment component can, in some cases, facilitate such check by attempting to execute the now-modified copy/duplicate on the specific quantum computing system. If such attempted execution is unsuccessful (e.g., if the specific quantum computing system returns one or more compilation errors and/or one or more runtime errors in response to such attempted execution), the adjustment component can conclude that the now-modified copy/duplicate is not executable on the specific quantum computing system. In contrast, if such attempted execution is successful (e.g., if the specific quantum computing system does not return one or more compilation errors and/or one or more runtime errors in response to such attempted execution), the adjustment component can instead conclude that the now-modified copy/duplicate is executable on the specific quantum computing system.

As also mentioned above, the adjustment component can, in other cases, facilitate such check by: commensurately modifying/adjusting the training coupling map; and computing a new similarity score between the now-modified training coupling map and the coupling map of the specific quantum computing system.

Again, as explained above, the adjustment component can create the now-modified copy/duplicate of the QML model by removing the lowest-scoring logical qubit (e.g., by removing all quantum gates that operate on the lowest-scoring logical qubit). Suppose that such lowest-scoring logical qubit is implemented by one or more particular qubits of the training coupling map (e.g., error mitigation can require multiple physical qubits to implement a single logical qubit). Accordingly, in various aspects, the adjustment component can remove those one or more particular qubits (and their corresponding qubit-to-qubit connections) from the training coupling map, thereby yielding a modified version of the training coupling map. Thus, the map component can compute a new similarity score, as described above, between that modified version of the training coupling map and the coupling map of the specific quantum computing system. If such new similarity score satisfies the threshold similarity score, then the adjustment component can conclude that the now-modified copy/duplicate of the QML model is executable on the specific quantum computing system. In contrast, if such new similarity score fails to satisfy the threshold similarity score, then the adjustment component can conclude that the now-modified copy/duplicate of the QML model is not yet executable on the specific quantum computing system.

In any case, the adjustment component can check whether or not the now-modified copy/duplicate of the QML model is executable on the specific quantum computing system. If that now-modified copy/duplicate is not yet executable on the specific quantum computing system, the adjustment component can remove/delete from the copy/duplicate whichever of the remaining b−1 logical qubits now has a lowest/smallest qubit score (e.g., can remove/delete every quantum gate that operates on that new lowest-scoring logical qubit), thereby causing the now-modified copy/duplicate to have b−2 logical qubits (e.g., where b−2>0).

In this way, the adjustment component can generate an adjusted version of the QML model that corresponds to the specific quantum computing system by: replicating the QML model; and iteratively eliminating/discarding logical qubits from the replica in order of qubit score, until whatever remains of the replica is executable on the specific quantum computing system.

The above examples pertaining to the adjustment component are non-limiting. In various embodiments, the adjustment component can create an adjusted/modified version of the QML model by removing, in order of increasing variable importance score, one or more quantum gates and/or one or more logical qubits from the QML model at a time (e.g., at each iteration). In various other embodiments, the adjustment component can create an adjusted/modified version of the QML model by removing, in random order, one or more quantum gates and/or one or more logical qubits from the QML model at a time (e.g., at each iteration).

In any case, when none of the similarity scores computed by the map component satisfy the threshold similarity score, the adjustment component can generate one or more adjusted versions of the QML model for each quantum computing system in the quantum computing system vault, thereby yielding a set of adjusted versions of the QML model that respectively correspond to the quantum computing systems in the vault.

In various embodiments, the adjustment component can further electronically generate a set of accuracy levels based on the set of adjusted versions of the QML model and/or based on the test data. More specifically, as mentioned above, the test data can include a set of input quantum states and a respectively corresponding set of output quantum states, where the output quantum states can be considered as respective ground-truths for the input quantum states. Furthermore, as mentioned above, each adjusted version of the QML model can be considered as corresponding to (e.g., as being executable on) a quantum computing system in the vault.

Accordingly, in various aspects, for each adjusted version of the QML model, the adjustment component can: (1) identify the quantum computing system that corresponds to (e.g., that has been checked as being able to execute) the adjusted version of the QML model; (2) select an input quantum state and a corresponding output quantum state from the test data; (3) initialize the identified quantum computing system with the selected input quantum state; (4) execute the adjusted version of the QML model on the identified and initialized quantum computing system, thereby yielding a resultant quantum state; (5) compute a difference between the resultant quantum state and the selected output quantum state; (6) repeat (2)-(5) until all of the test data are used, thereby yielding a set of computed differences; and/or (7) compute an accuracy score (e.g., a real-valued scalar) for the adjusted version of the QML model based on the set of computed differences. The accuracy score can be any suitable function of such set of computed differences. As a non-limiting example, the accuracy score can be based on a reciprocal of the average (e.g., mean) of the set of computed differences, such that the value/magnitude of the accuracy score can increase as the average of the set of computed differences decreases.

In this way, the adjustment component can calculate an accuracy score for each adjusted version of the QML model.

In various embodiments, there can be an adjusted version of the QML model that has a highest and/or best accuracy score, and, in various aspects, the selection component of the computerized tool can electronically select whichever quantum computing system corresponds to (e.g., has been checked as being able to execute) such most-accurate adjusted version of the QML model. If two or more adjusted versions of the QML model have the highest/best accuracy score, then the selection component can electronically identify the quantum computing systems that correspond to such two or more adjusted versions of the QML model and can select from among such quantum computing systems according to any suitable order of priority (e.g., can select whichever of such quantum computing systems is available and/or has the lowest queue time, can select whichever of such quantum computing systems has the longest coherence times and/or the smallest noise/error levels).

In such case, the execution component of the computerized tool can electronically generate, transmit to any suitable computing device, and/or visually display/render on any suitable computer screen an electronic message, where the electronic message can indicate that none of the quantum computing systems in the vault are appropriate for the QML model (e.g., for the original, unaltered version of the QML model). However, in various aspects, the electronic message can further indicate that the selected quantum computing system is appropriate for the adjusted version of the QML model that has the highest/best accuracy score.

In some instances, the access component can further access a user-provided quantum state initialization which is desired to be analyzed by the QML model. In various cases, the execution component can: initialize the selected quantum computing system with the user-provided quantum state initialization; execute the adjusted version of the QML model having the highest/best accuracy score on the initialized selected quantum computing system, thereby yielding a resultant quantum state; and/or display on any suitable computer screen and/or transmit to any suitable computing device the resultant quantum state.

Accordingly, various embodiments described herein can be considered as a computerized tool that can identify/determine which one from a set of quantum computing systems is most appropriate for a given QML model. As described herein, such computerized tool can facilitate such identification/determination by respectively comparing coupling maps of the set of quantum computing systems to a particular coupling map on which the given QML model was trained. In various instances, even if a topologically matching coupling map is not found, the computerized tool can generate various adjusted/relaxed versions of the QML model that are executable on various of the set of quantum computing systems, and the computerized tool can identify/determine which of such adjusted/relaxed versions is/are most accurate (e.g., which adjusted/relaxed version(s) exhibit(s) sufficiently high performance).

Various embodiments described herein can be employed to use hardware and/or software to solve problems that are highly technical in nature (e.g., to facilitate quantum system selection via coupling map comparison), that are not abstract and that cannot be performed as a set of mental acts by a human. Further, some of the processes performed can be performed by a specialized computer (e.g., quantum computers that can execute/implement quantum machine learning models). In various aspects, some defined tasks associated with various embodiments described herein can include: accessing, by a device operatively coupled to at least one processor, a quantum machine learning model; identifying, by the device and from a set of quantum computing systems, a quantum computing system for the quantum machine learning model, based on a comparison between a first coupling map of the quantum computing system and a second coupling map on which the quantum machine learning model was trained; and/or executing, by the device, the quantum machine learning model or an adjusted version of the quantum machine learning model on the quantum computing system. In various instances, such defined tasks can further include: determining, by the device, that the second coupling map does not topologically match the first coupling map and does not topologically match any subgraph of the first coupling map; accessing, by the device, a set of variable importance scores associated with the quantum machine learning model; and/or adjusting, by the device and based on the set of variable importance scores, the quantum machine learning model, thereby yielding the adjusted version of the quantum machine learning model, wherein the device is configured to execute the adjusted version of the quantum machine learning model on the quantum computing system.

Neither the human mind nor a human with pen and paper can electronically access a QML model and a set of quantum computers, electronically compare (e.g., via computation of subgraph matching metrics) coupling maps of the quantum computers to a specific coupling map on which the QML model was trained; electronically adjust the QML model (e.g., by removing quantum gates and/or logical qubits from the QML model in order of variable importance score), and electronically execute the adjusted version of the QML model on one of the quantum computers. Instead, such defined tasks are inherently and inextricably tied to computer technology and cannot be implemented outside of a computing environment. After all, a quantum computer is a specialized piece of computing hardware that utilizes physical qubits (e.g., superconducting qubits, such a transmons) to process information. Physical qubits cannot be implemented by the human mind or by a human with pen and paper. Moreover, a QML model can be a sequence of quantum gates that can be executed on a quantum computer and whose internal parameters can be iteratively learned through training. Neither the human mind, nor a human with pen and paper, can execute quantum circuits on physical qubits. Therefore, a computerized tool that can compare coupling maps of quantum computers to the coupling map on which a QML model was trained, that can remove quantum gates and/or logical qubits from a QML model, and/or that can execute a QML model on a quantum computer is inherently computerized and cannot be implemented in any sensible, practicable, or reasonable way without computers.

In various instances, one or more embodiments described herein can integrate the herein-described teachings into a practical application. As mentioned above, existing techniques for selecting a quantum computing system for execution of a given QML model rely upon overly-simplistic heuristics, such as total number of qubits. As explained above, such overly-simplistic heuristics are prone to selecting inappropriate quantum computing systems (e.g., are prone to selecting quantum computers that cannot perform the given QML model in an acceptable manner). To address this significant technical problem, the present inventors devised a technique for selecting quantum computing systems based on coupling map comparison. More specifically, such technique can include comparing (e.g., via subgraph matching metrics) coupling maps of quantum computing systems with a particular coupling map on which a QML model was trained. If a quantum computing system is found such that the coupling map, or a subgraph thereof, topologically matches the particular coupling map on which the given QML model was trained, such quantum computing system can be considered as appropriate for the QML model (e.g., such quantum computing system can support the entangling gates included in the QML model). In contrast, if there is no quantum computing system whose coupling map, or a subgraph thereof, topologically matches the particular coupling map on which the given QML model was trained, such technique can further include creating various adjusted/relaxed versions of the QML model (e.g., by iteratively removing/deleting quantum gates and/or logical qubits from the QML model in order of variable importance score) that are executable on respective ones of the quantum computing systems and conducting test runs to identify/determine which of such adjusted/relaxed versions is most accurate (e.g., is least inaccurate). Accordingly, the technique described herein can identify on which of a set of quantum computing systems a given QML model (and/or an adjusted/relaxed version of the given QML model) should be executed. Because such technique can leverage coupling map comparison, such technique can be much less likely to identify an inappropriate quantum computing system, as opposed to existing techniques that rely upon overly-simplistic heuristics or that otherwise rely upon trial-and-error techniques. This is a concrete and tangible technical improvement in the field of quantum systems. For at least these reasons, various embodiments described herein certainly constitute useful and practical applications of computers.

It should be appreciated that the figures and the herein disclosure describe non-limiting examples of various embodiments. It should further be appreciated that the figures are not necessarily drawn to scale.

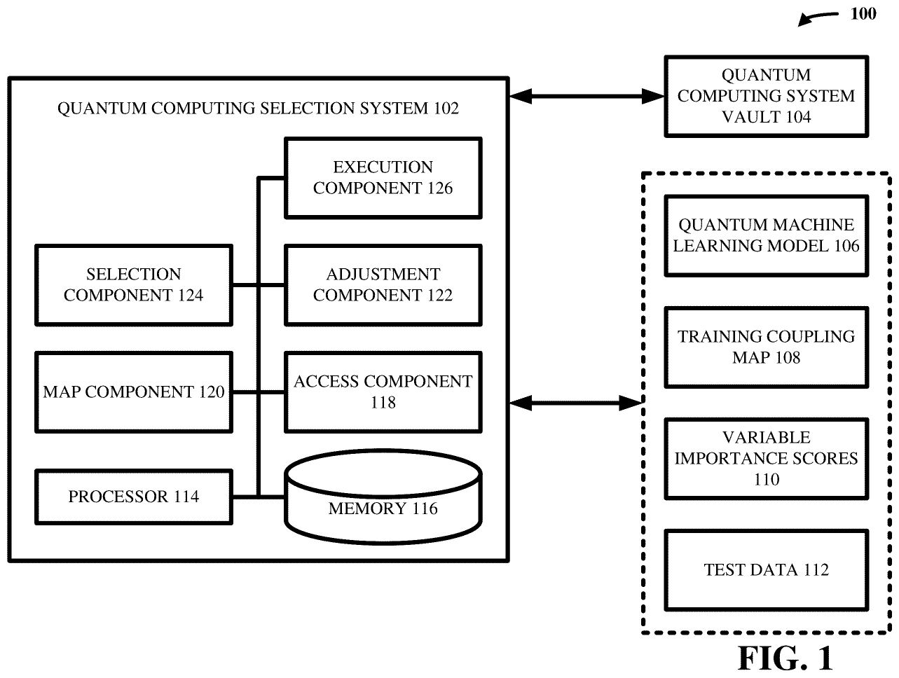

FIG. 1 illustrates a block diagram of an example, non-limiting system 100 that can facilitate quantum system selection via coupling map comparison in accordance with one or more embodiments described herein. As shown, a quantum computing selection system 102 can be electronically integrated, via any suitable wired and/or wireless electronic connections, to a quantum computing system vault 104, to a quantum machine learning model 106 (hereafter “QML model 106”), to a training coupling map 108, to a set of variable importance scores 110, and/or to test data 112.

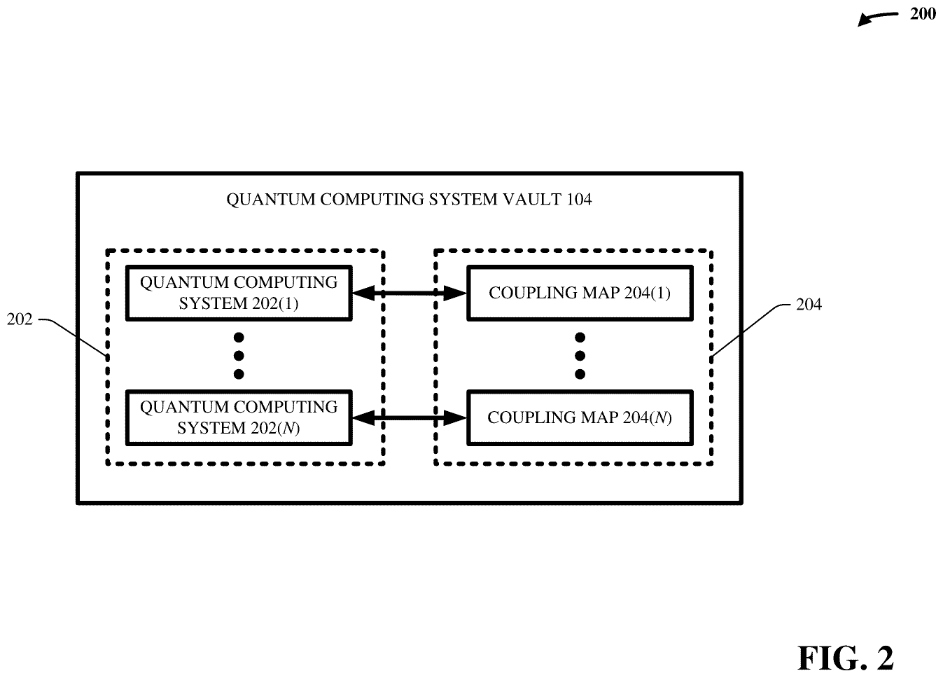

In various embodiments, the quantum computing system vault 104 can be any suitable centralized and/or decentralized collection, centralized and/or decentralized set, centralized and/or decentralized group, centralized and/or decentralized store, and/or centralized and/or decentralized warehouse of quantum computing systems. In various other embodiments, the quantum computing system vault 104 can be any suitable centralized and/or decentralized database that stores electronic information (e.g., metadata) pertaining to and/or describing various quantum computing systems. In any case, each quantum computing system in the quantum computing system vault 104 can correspond to a respective coupling map. This is further described with respect to FIG. 2.

FIG. 2 illustrates an example, non-limiting block diagram 200 of the quantum computing system vault 104 in accordance with one or more embodiments described herein. As shown, the quantum computing system vault 104 can, in various aspects, include a set of quantum computing systems 202 and/or a set of coupling maps 204.

In various instances, the set of quantum computing systems 202 can include n quantum computing systems for any suitable positive integer n: a quantum computing system 202(1) to a quantum computing system 202(n). In various cases, each of the set of quantum computing systems 202 can exhibit any suitable quantum computing architectures and/or quantum computing structures. For example, the quantum computing system 202(1) can have any suitable number of any suitable types of qubits (e.g., superconducting qubits, such as transmons), where such qubits can be fabricated according to any suitable microfabrication and/or nanofabrication techniques (e.g., photolithography, deposition, etching, double-angle evaporation), and/or where such qubits can be connected/coupled together in any suitable fashion/arrangement/topology. As another example, the quantum computing system 202(n) can likewise have any suitable number of any suitable types of qubits, where such qubits can be fabricated according to any suitable microfabrication and/or nanofabrication techniques, and/or where such qubits can be connected/coupled together in any suitable fashion/arrangement/topology. In various cases, different ones of the set of quantum computing systems 202 can have the same and/or different numbers/types of qubits as each other, can be manufactured according to the same and/or different fabrication techniques as each other, and/or can exhibit the same and/or different connection topologies as each other.

In various aspects, the set of coupling maps 204 can respectively correspond (e.g., in one-to-one fashion) to the set of quantum computing systems 202. Accordingly, since the set of quantum computing systems 202 can include n quantum computing systems, the set of coupling maps 204 can include n coupling maps: a coupling map 204(1) to a coupling map 204(n). In various instances, each of the set of coupling maps 204 can be a graph data structure representing and/or describing the connection topology of a respectively corresponding one of the set of quantum computing systems 202. For example, the coupling map 204(1) can correspond to the quantum computing system 202(1). That is, the coupling map 204(1) can be a graph data structure containing vertices and edges, where each of such vertices can represent a respectively corresponding one of the qubits in the quantum computing system 202(1), and/or where each of such edges can represent a respectively corresponding qubit-to-qubit connection in the quantum computing system 202(1). In some cases, the coupling map 204(1) can be an unweighted graph data structure. In other cases, however, the coupling map 204(1) can be a weighted graph data structure. Indeed, in such cases, the vertices and/or edges of the coupling map 204(1) can be weighted according to any suitable properties and/or attributes of the qubits and/or qubit-to-qubit connections of the quantum computing system 202(1). Non-limiting examples of properties/attributes that can be used for weighting can include transition frequencies of the qubits in the quantum computing system 202(1), decoherence times of the qubits in the quantum computing system 202(1), relaxation times of the qubits in the quantum computing system 202(1), noise levels of the qubits in the quantum computing system 202(1), error rates of the qubits in the quantum computing system 202(1), fidelities of the qubits in the quantum computing system 202(1), and/or entanglement strengths of the couplers in the quantum computing system 202(1).

As another example, the coupling map 204(n) can correspond to the quantum computing system 202(n). So, the coupling map 204(n) can be a graph data structure containing vertices and edges, where each of such vertices can represent a respectively corresponding one of the qubits in the quantum computing system 202(n), and/or where each of such edges can represent a respectively corresponding qubit-to-qubit connection in the quantum computing system 202(n). Just as above, in some cases, the coupling map 204(n) can be an unweighted graph data structure. In other cases, however, the coupling map 204(n) can be a weighted graph data structure. As mentioned above, in such cases, the vertices and/or edges of the coupling map 204(n) can be weighted according to any suitable properties and/or attributes of the qubits and/or qubit-to-qubit connections of the quantum computing system 202(n). Non-limiting examples of such properties/attributes that can be used for weighting can include transition frequencies of the qubits in the quantum computing system 202(n), decoherence times of the qubits in the quantum computing system 202(n), relaxation times of the qubits in the quantum computing system 202(n), noise levels of the qubits in the quantum computing system 202(n), error rates of the qubits in the quantum computing system 202(n), fidelities of the qubits in the quantum computing system 202(n), and/or entanglement strengths of the couplers in the quantum computing system 202(n).

Referring back to FIG. 1, in various embodiments, the QML model 106 can be any suitable parametrized quantum circuit made up of any suitable sequence of series and/or parallel quantum gates that collectively operate on any suitable number of qubits (e.g., of logical qubits). In various aspects, internal parameters of the QML model 106 can be iteratively obtained through any suitable training process for machine learning (e.g., supervised and/or unsupervised training). In various aspects, the QML model 106 can be trained on any suitable quantum computing system, which may and/or may not be within the quantum computing system vault 104. In some cases, quantum computing system that trained the QML model 106 can be within the quantum computing system vault 104, but such quantum computing system can be unavailable (e.g., can be occupied by a consumer, and/or can be temporarily offline due to qubit burnout).

In various instances, the training coupling map 108 can be a graph data structure representing and/or describing the connection topology of that particular quantum computing system on which the QML model 106 was trained. That is, the training coupling map 108 can be a graph data structure containing vertices and edges, where each of such vertices can represent a respectively corresponding one of the qubits in the particular quantum computing system on which the QML model 106 was trained, and/or where each of such edges can represent a respectively corresponding qubit-to-qubit connection in the particular quantum computing system on which the QML model 106 was trained. Just as above, the training coupling map 108 can be an unweighted graph data structure in some cases. In other cases, the training coupling map 108 can be a weighted graph data structure. That is, the vertices and/or edges of the training coupling map 108 can be weighted according to any suitable properties, attributes, and/or parameters of the qubits and/or qubit-to-qubit connections of the particular quantum computing system on which the QML model 106 was trained. Non-limiting examples of such properties, attributes, and/or parameters can include transition frequencies, decoherence times, relaxation times, noise levels, error rates, fidelities, and/or entanglement strengths.

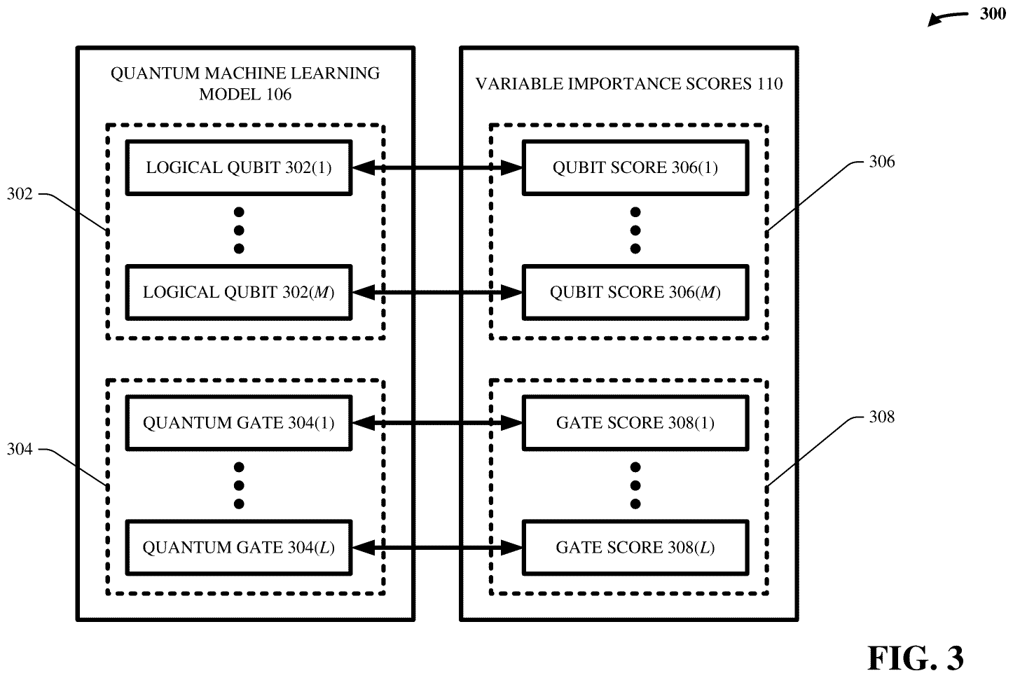

In various embodiments, the set of variable importance scores 110 can be a set of real-valued scalars, each of which can represent and/or describe a relative level of importance of a quantum gate and/or of a logical qubit that is utilized by the QML model 106. This is further described with respect to FIG. 3.

FIG. 3 illustrates an example, non-limiting block diagram 300 of the QML model 106 and/or of the set of variable importance scores 110 in accordance with one or more embodiments described herein.

In various embodiments, as shown, the QML model 106 can include a set of logical qubits 302 and/or a set of quantum gates 304. In various aspects, the set of logical qubits 302 can include m qubits for any suitable positive integer m: a logical qubit 302(1) to a logical qubit 302(m). In various instances, this can mean that the QML model 106 can be configured to operate on quantum states having a dimensionality of 2^{m}. In various cases, the set of quantum gates 304 can include l gates for any suitable positive integer l: a quantum gate 304(1) to a quantum gate 304(l). In various aspects, as mentioned above, a quantum gate can be any suitable single-qubit quantum gate and/or any suitable two-qubit quantum gate. Non-limiting examples of such quantum gates can include Pauli-X gates, Pauli-Y gates, Pauli-Z gates, Phase gates, Hadamard gates, Controlled-Not gates, Controlled-Phase gates, Controlled-Z gates, and/or Rotation gates. In any case, the set of quantum gates 304 can be arranged in any suitable fashion (e.g., in series and/or in parallel with each other), so as to collectively operate on the set of logical qubits 302.

In various aspects, as shown, the set of variable importance scores 110 can include a set of qubit scores 306 and/or a set of gate scores 308. In various instances, the set of qubit scores 306 can respectively correspond (e.g., in one-to-one fashion) to the set of logical qubits 302. Accordingly, since the set of logical qubits 302 can include m qubits, the set of qubit scores 306 can include m scores: a qubit score 306(1) to a qubit score 306(m). In various cases, each of the set of qubit scores 306 can be a real-valued scalar whose magnitude represents and/or indicates a relative level of importance of a respectively corresponding one of the set of logical qubits 302 to the functionality and/or operability of the QML model 106. For example, the qubit score 306(1) can correspond to the logical qubit 302(1), meaning that the qubit score 306(1) can be a real-valued scalar whose value indicates how important and/or how unimportant, relative to the other logical qubits in the set of logical qubits 302, the logical qubit 302(1) is to facilitating the functionality/operability of the QML model 106 (e.g., a higher value of the qubit score 306(1) can indicate that the logical qubit 302(1) is more important to the QML model 106, whereas a lower value of the qubit score 306(1) can indicate that the logical qubit 302(1) is less important to the QML model 106). As another example, the qubit score 306(m) can correspond to the logical qubit 302(m), meaning that the qubit score 306(m) can be a real-valued scalar whose value indicates how important and/or how unimportant, relative to the other logical qubits in the set of logical qubits 302, the logical qubit 302(m) is to facilitating the functionality/operability of the QML model 106 (e.g., a higher value of the qubit score 306(m) can indicate that the logical qubit 302(m) is more important to the QML model 106, whereas a lower value of the qubit score 306(m) can indicate that the logical qubit 302(m) is less important to the QML model 106).

Likewise, in various aspects, the set of gate scores 308 can respectively correspond (e.g., in one-to-one fashion) to the set of quantum gates 304. So, since the set of quantum gates 304 can include l gates, the set of gate scores 308 can include l scores: a gate score 308(1) to a gate score 308(l). In various instances, each of the set of gate scores 308 can be a real-valued scalar whose magnitude represents and/or indicates a relative level of importance of a respectively corresponding one of the set of quantum gates 304 to the functionality and/or operability of the QML model 106. For example, the gate score 308(1) can correspond to the quantum gate 304(1), meaning that the gate score 308(1) can be a real-valued scalar whose value indicates how important and/or how unimportant, relative to the other quantum gates in the set of quantum gates 304, the quantum gate 304(1) is to facilitating the functionality/operability of the QML model 106 (e.g., a higher value of the gate score 308(1) can indicate that the quantum gate 304(1) is more important to the QML model 106, whereas a lower value of the gate score 308(1) can indicate that the quantum gate 304(1) is less important to the QML model 106). As another example, the gate score 308(l) can correspond to the quantum gate 304(l), meaning that the gate score 308(l) can be a real-valued scalar whose value indicates how important and/or how unimportant, relative to the other quantum gates in the set of quantum gates 304, the quantum gate 304(l) is to facilitating the functionality/operability of the QML model 106 (e.g., a higher value of the gate score 308(l) can indicate that the quantum gate 304(l) is more important to the QML model 106, whereas a lower value of the gate score 308(l) can indicate that the quantum gate 304(l) is less important to the QML model 106).

In various embodiments, the set of variable importance scores 110 can be generated via any suitable quantum circuit analysis techniques. As a non-limiting example, univariate Fisher scores can be computed for the QML model 106, and the set of variable importance scores 110 can be equal to and/or otherwise based on such univariate Fisher scores. As another non-limiting example, local scope Shapley values can be computed for the QML model 106, and the set of variable importance scores 110 can be equal to and/or otherwise based on such local scope Shapley values. As yet another non-limiting example, norms of the learnable parameters of the QML model 106 with respect to the input variables of the QML model 106 can be computed, and the set of variable importance scores 110 can be equal to and/or otherwise based on such norms.

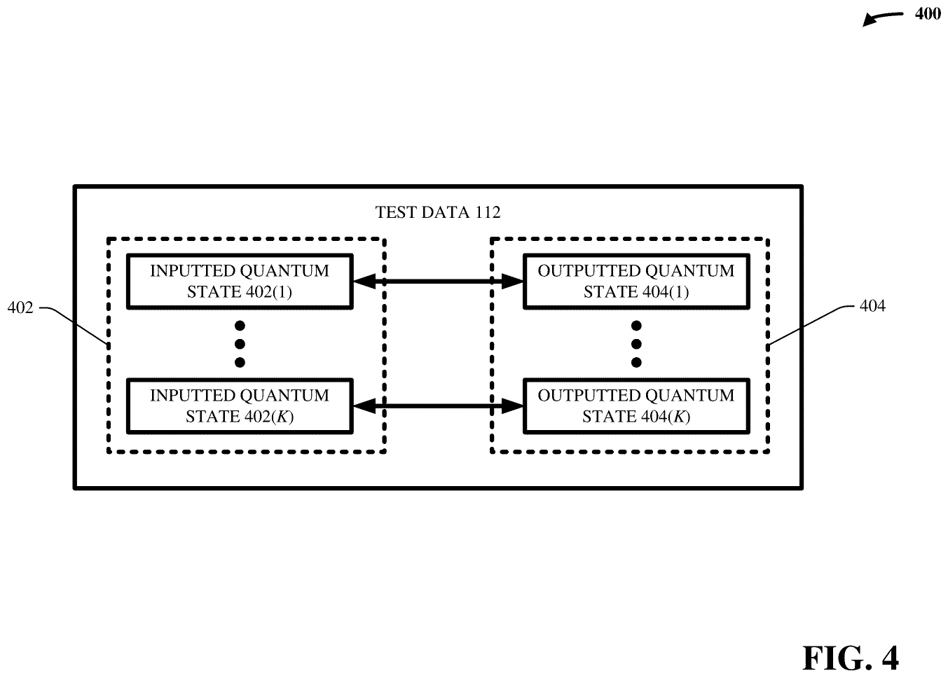

Referring back to FIG. 1, in various embodiments, the test data 112 can be considered as representing various inputted quantum states and various respectively corresponding outputted quantum states. This is further described with respect to FIG. 4.

FIG. 4 illustrates an example, non-limiting block diagram 400 of the test data 112 in accordance with one or more embodiments described herein.

As shown, the test data 112 can include a set of inputted quantum states 402 and/or a set of outputted quantum states 404. In various aspects, the set of inputted quantum states 402 can include k quantum states for any suitable positive integer k: an inputted quantum state 402(1) to an inputted quantum state 402(k). In various instances, the set of outputted quantum states 404 can respectively correspond (e.g., in one-to-one fashion) to the set of inputted quantum states 402. Accordingly, since the set of inputted quantum states 402 can include k quantum states, the set of outputted quantum states 404 can likewise include k quantum states: an outputted quantum state 404(1) to an outputted quantum state 404(k). In various cases, each of the set of inputted quantum states 402 and/or each of the set of outputted quantum states 404 can be a vector having a dimensionality of 2^{m}. In various aspects, the set of outputted quantum states 404 can be considered as ground-truths that are known and/or otherwise deemed to correspond to the set of inputted quantum states 402. For example, the outputted quantum state 404(1) can be a ground-truth that is known/deemed to correspond to the inputted quantum state 402(1). Likewise, the outputted quantum state 404(k) can be a ground-truth that is known/deemed to correspond to the inputted quantum state 402(k).

Although the herein disclosure mainly describes various embodiments in which each of the set of inputted quantum states 402 has a same size/dimensionality as each of the set of outputted quantum states 404, this is a mere non-limiting example for ease of illustration and/or explanation. In various aspects, an outputted quantum state can have a different size/dimensionality than a corresponding inputted quantum state. For example, in some cases, the inputted quantum state 402(1) can have a dimensionality of 2^{m}, and the outputted quantum state 404(1) can have a dimensionality of 2^{q}, where q≠m (e.g., where q<m). In other words, the output which the QML model 106 is configured to produce can, in some cases, have a different size/dimensionality than the input that the QML model 106 is configured to receive.

Referring back to FIG. 1, it can be desired to determine which quantum computing system from the quantum computing system vault 104 is appropriate for the QML model 106. As described herein, the quantum computing selection system 102 can facilitate such determination, based on the training coupling map 108, the set of variable importance scores 110, and/or the test data 112.

In various embodiments, the quantum computing selection system 102 can comprise a processor 114 (e.g., computer processing unit, microprocessor) and a non-transitory computer-readable memory 116 that is operably connected and/or coupled to the processor 114. The memory 116 can store computer-executable instructions which, upon execution by the processor 114, can cause the processor 114 and/or other components of the quantum computing selection system 102 (e.g., access component 118, map component 120, adjustment component 122, selection component 124, and/or execution component 126) to perform one or more acts. In various embodiments, the memory 116 can store computer-executable components (e.g., access component 118, map component 120, adjustment component 122, selection component 124, and/or execution component 126), and the processor 114 can execute the computer-executable components.

In various embodiments, the quantum computing selection system 102 can comprise an access component 118. In various aspects, the access component 118 can electronically access, in any suitable fashion, the quantum computing system vault 104, such that the quantum computing selection system 102 can electronically initialize, electronically activate (e.g., power-up), electronically deactivate (e.g., power-down), and/or otherwise electronically control/access the set of quantum computing systems 202. Furthermore, in various instances, the access component 118 can electronically receive, retrieve, obtain, import, and/or otherwise access, from any suitable data structures and/or from any suitable computing devices, the QML model 106, the training coupling map 108, the set of variable importance scores 110, and/or the test data 112. For example, a user-device (e.g., a laptop computer of a user, a desktop computer of a user, and/or a smart phone of a user) can electronically transmit the QML model 106, the training coupling map 108, the set of variable importance scores 110, and/or the test data 112 to the access component 118. In any case, the access component 118 can electronically access (e.g., send and/or receive data and/or program instructions to/from) the quantum computing system vault 104, the QML model 106, the training coupling map 108, the set of variable importance scores 110, and/or the test data 112, so that other components of the quantum computing selection system 102 can electronically interact with the quantum computing system vault 104, the QML model 106, the training coupling map 108, the set of variable importance scores 110, and/or the test data 112.

In various embodiments, the quantum computing selection system 102 can further comprise a map component 120. In various aspects, as described herein, the map component 120 can generate a set of coupling map similarity scores based on the quantum computing system vault 104 and/or based on the training coupling map 108.

In various embodiments, the quantum computing selection system 102 can further comprise an adjustment component 122. In various instances, as described herein, the adjustment component 122 can generate a set of adjusted versions of the QML model 106 based on the set of coupling map similarity scores, based on the set of variable importance scores 110, and/or based on the test data 112.

In various embodiments, the quantum computing selection system 102 can further comprise a selection component 124. In various cases, as described herein, the selection component 124 can select/identify, from the quantum computing system vault 104, a quantum computing system that is appropriate for the QML model 106, based on the set of coupling map similarity scores and/or based on the set of adjusted versions of the QML model 106.

In various embodiments, the quantum computing selection system 102 can further comprise an execution component 126. In various aspects, as described herein, the execution component 126 can execute the QML model 106, and/or an adjusted version of the QML model 106, on the selected quantum computing system.

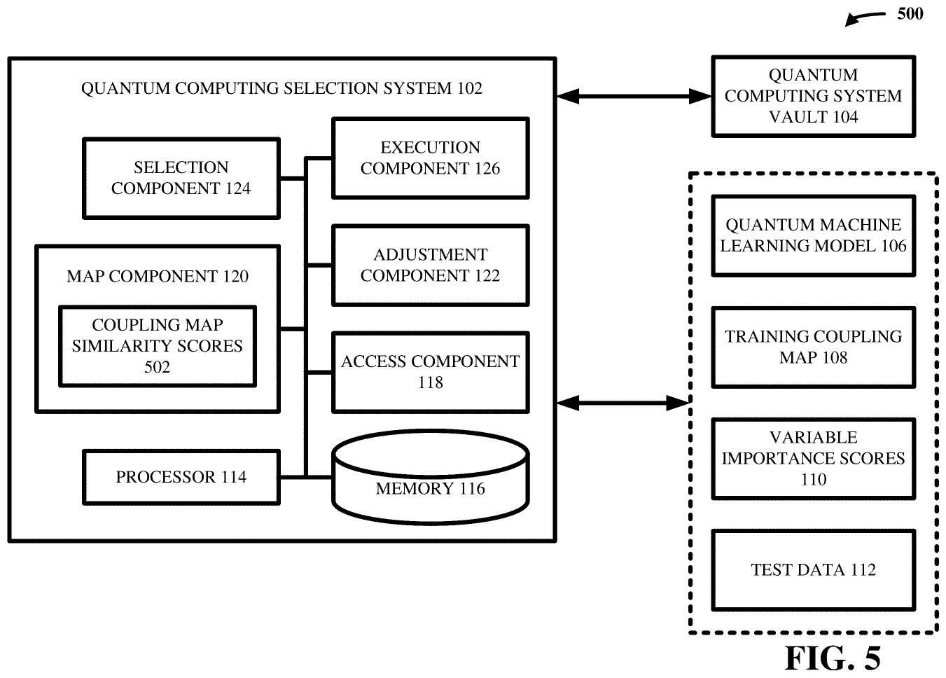

FIG. 5 illustrates a block diagram of an example, non-limiting system 500 including a set of coupling map similarity scores that can facilitate quantum system selection via coupling map comparison in accordance with one or more embodiments described herein. As shown, the system 500 can, in some cases, comprise the same components as the system 100, and can further comprise a set of coupling map similarity scores 502.

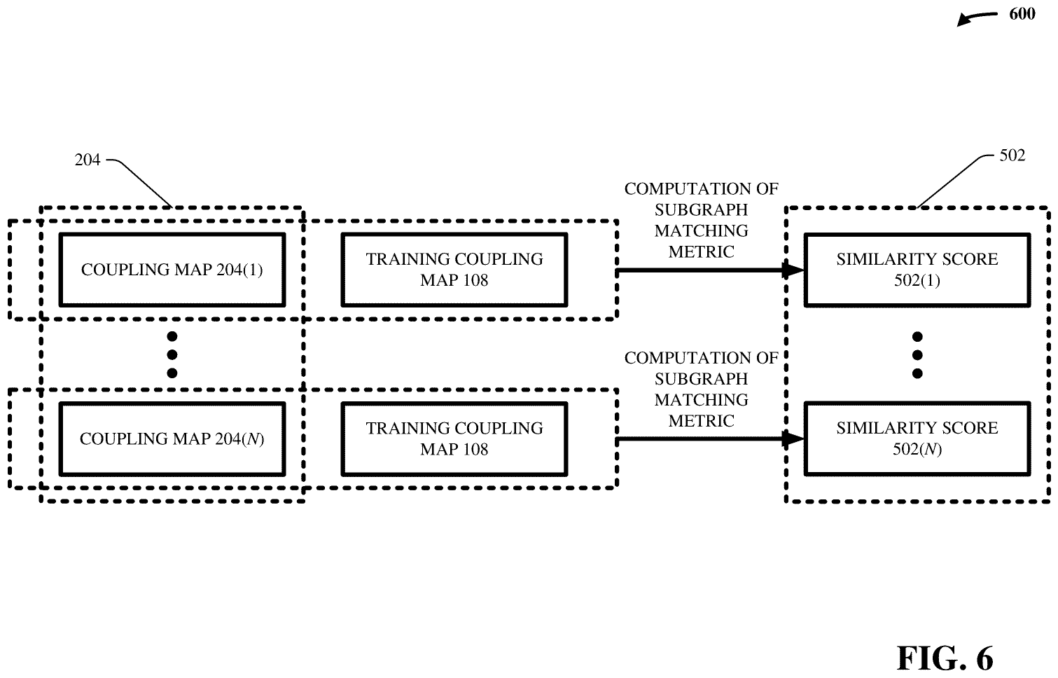

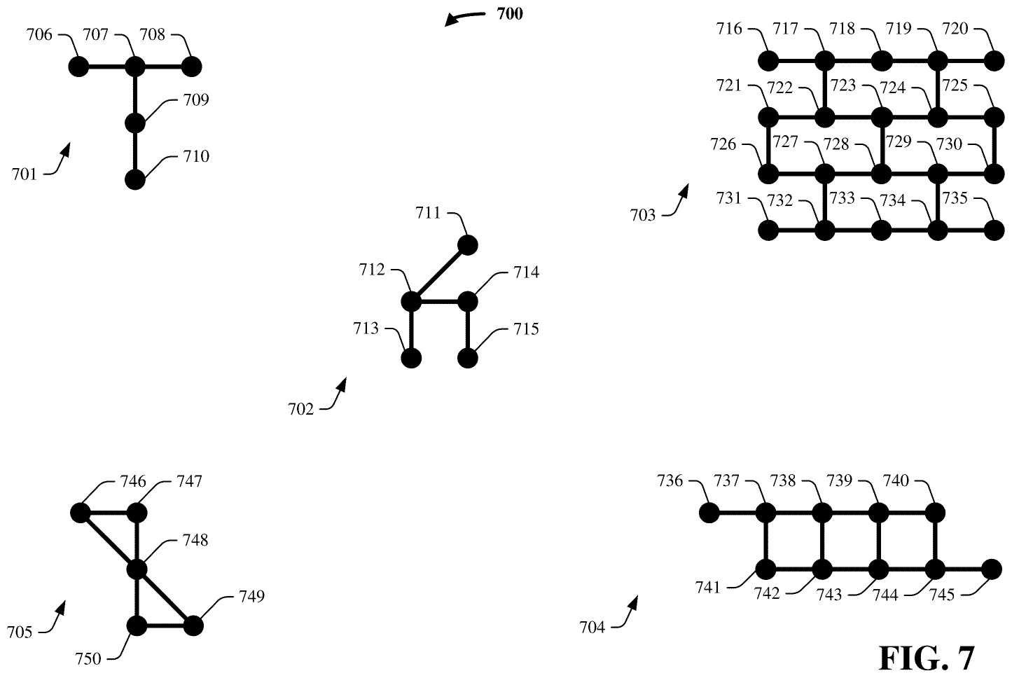

In various embodiments, the map component 120 can electronically generate the set of coupling map similarity scores 502, based on the quantum computing system vault 104 and/or based on the training coupling map 108. In various aspects, the set of coupling map similarity scores 502 can be considered as indicating how similar and/or how dissimilar respective ones of the set of coupling maps 204 are with respect to the training coupling map 108. This is further described with respect to FIGS. 6-7.

FIGS. 6-7 illustrate example, non-limiting block diagrams 600 and 700 showing how the set of coupling map similarity scores 502 can be generated in accordance with one or more embodiments described herein.

In various embodiments, as shown in FIG. 6, the set of coupling map similarity scores 502 can respectively correspond (e.g., in one-to-one fashion) to the set of coupling maps 204. Accordingly, because the set of coupling maps 204 can include n maps, the set of coupling map similarity scores 502 can include n scores; a similarity score 502(1) to a similarity score 502(n).

In various aspects, the map component 120 can generate the set of coupling map similarity scores 502 by comparing the training coupling map 108 to respective ones of the set of coupling maps 204.

For example, as shown, the similarity score 502(1) can correspond to the coupling map 204(1). Accordingly, the map component 120 can compute the similarity score 502(1) by comparing the coupling map 204(1) to the training coupling map 108. More specifically, the similarity score 502(1) can be a real-valued scalar whose continuously-varying and/or discretely-varying magnitude can indicate, represent, and/or otherwise convey how similar and/or how dissimilar the coupling map 204(1) is to the training coupling map 108. More specifically still, the map component 120 can generate the similarity score 502(1) by computing any suitable subgraph matching metric between the coupling map 204(1) and the training coupling map 108.

As mentioned above, a subgraph matching metric can be any suitable function and/or any suitable algorithm from graph theory, which function/algorithm can take as an argument two graphs and can produce as a result a scalar representing how far apart the two inputted graphs are from each other (e.g., representing how different the arrangements of vertices and edges are between the two inputted graphs, and/or representing how different the vertex/edge properties are between the two inputted graphs). As a non-limiting example, a subgraph matching metric can be a Gromov-Hausdorff distance. As another non-limiting example, a subgraph matching metric can be a Manhattan distance. As yet another non-limiting example, a subgraph matching metric can be a graph edit distance. As even another non-limiting example, a subgraph matching metric can be a Min/Max similarity measure. In various cases, the degree of similarity between two graphs can decrease as the magnitude of a subgraph matching metric between such two graphs increases (e.g., such increased subgraph matching metric can indicate more distance between the two graphs, which can mean less similarity and more dissimilarity).

Thus, in various aspects, the map component 120 can compute a subgraph matching metric (e.g., a Gromov-Hausdorff distance, a Manhattan distance, a graph edit distance) between the coupling map 204(1) and the training coupling map 108, and the map component 120 can calculate the similarity score 502(1) based on such subgraph matching metric. In some instances, the similarity score 502(1) can be equal to the subgraph matching metric. In such case, the degree of similarity between the coupling map 204(1) and the training coupling map 108 can decrease as the value/magnitude of the similarity score 502(1) increases. In other instances, the similarity score 502(1) can be any other suitable mathematical function of the subgraph matching metric. For example, the similarity score 502(1) can be based on a reciprocal of the subgraph matching metric. In such case, the degree of similarity between the coupling map 204(1) and the training coupling map 108 can increase as the value/magnitude of the similarity score 502(1) increases. In any case, the similarity score 502(1) can indicate how similar and/or how dissimilar (in terms of arrangement of qubits, arrangement of qubit-to-qubit connections, properties/weights of qubits, and/or properties/weights of qubit-to-qubit connections) the coupling map 204(1) is as compared to the training coupling map 108.

As another example shown in FIG. 5, the similarity score 502(n) can correspond to the coupling map 204(n). Accordingly, the map component 120 can compute the similarity score 502(n) by comparing the coupling map 204(n) to the training coupling map 108. Just as above, the similarity score 502(n) can be a real-valued scalar whose continuously-varying and/or discretely-varying magnitude can indicate, represent, and/or otherwise convey how similar and/or how dissimilar the coupling map 204(n) is to the training coupling map 108. As also described above, the map component 120 can generate the similarity score 502(n) by computing any suitable subgraph matching metric (e.g., Gromov-Hausdorff distance, Manhattan distance, graph edit distance, Min/Max similarity measure) between the coupling map 204(n) and the training coupling map 108, and the map component 120 can calculate the similarity score 502(n) based on such subgraph matching metric. In some instances, the similarity score 502(n) can be equal to the subgraph matching metric. In such case, the degree of similarity between the coupling map 204(n) and the training coupling map 108 can decrease as the value/magnitude of the similarity score 502(n) increases. In other instances, the similarity score 502(n) can be any other suitable mathematical function of the subgraph matching metric. For example, the similarity score 502(n) can be based on a reciprocal of the subgraph matching metric. In such case, the degree of similarity between the coupling map 204(n) and the training coupling map 108 can increase as the value/magnitude of the similarity score 502(n) increases. In any case, the similarity score 502(n) can indicate how similar and/or how dissimilar (in terms of arrangement of qubits, arrangement of qubit-to-qubit connections, properties/weights of qubits, and/or properties/weights of qubit-to-qubit connections) the coupling map 204(n) is as compared to the training coupling map 108.

Although not explicitly shown in the figures, there can be any suitable threshold similarity score. In various aspects, the threshold similarity score can denote and/or otherwise demarcate topological matching between any two coupling maps. More specifically, because the degree of similarity between any two coupling maps can decrease as a subgraph matching metric between such two coupling maps increases, the threshold similarity score can be equal to (and/or otherwise based on) whatever value/magnitude of similarity score corresponds to a minimal and/or minimized subgraph matching metric. As a non-limiting example, the threshold similarity score can be equal to whatever similarity score value indicates a Gromov-Hausdorff distance of zero. As another non-limiting example, the threshold similarity score can be equal to whatever similarity score value indicates a Manhattan distance of zero. As even another non-limiting example, the threshold similarity score can be equal to whatever similarity score value indicates a graph edit distance of zero. However, these are mere non-limiting examples. In various other cases, the threshold similarity score can be equal to (and/or otherwise based on) whatever value/magnitude of similarity score corresponds to any suitable pre-determined value of subgraph matching metric. As a non-limiting example, the threshold similarity score can be equal to whatever similarity score value indicates any suitable, pre-defined, non-zero Gromov-Hausdorff distance. As another non-limiting example, the threshold similarity score can be equal to whatever similarity score value indicates any suitable, pre-defined, non-zero Manhattan distance. As even another non-limiting example, the threshold similarity score can be equal to whatever similarity score value indicates any suitable, pre-defined, non-zero graph edit distance.

In any of these cases, when a similarity score between two coupling maps satisfies the threshold similarity score, it can be concluded that: (i) the two coupling maps topologically match each other; or (ii) at least one subgraph of one of the two coupling maps topologically matches the other of the two coupling maps. In contrast, when a similarity score between two coupling maps fails to satisfy the threshold similarity score, it can be concluded that: (iii) the two coupling maps do not topologically match each other; and (iv) no subgraph of either of the two coupling maps topologically matches the other of the two coupling maps.

Therefore, the map component 120 can compute a similarity score (e.g., one of 502) for each of the set of coupling maps 204, where such similarity score can either satisfy or fail to satisfy the threshold similarity score. For example, if the similarity score 502(1) satisfies the threshold similarity score, it can be concluded that the coupling map 204(1) has the same (or sufficiently similar) arrangement of qubits and qubit-to-qubit connections, and/or has the same (or sufficiently similar) qubit properties and/or qubit-to-qubit connection properties, as the training coupling map 108. This can mean that the QML model 106 can be accurately executed on the quantum computing system 202(1) without change, without modification, and/or otherwise as originally trained. That is, the quantum computing system 202(1) can be considered as appropriate for the QML model 106. On the other hand, if the similarity score 502(1) fails to satisfy the threshold similarity value, it can be concluded that the coupling map 204(1) does not have the same (or sufficiently similar) arrangement of qubits and qubit-to-qubit connections, and/or does not have the same (or sufficiently similar) qubit properties and qubit-to-qubit connection properties, as the training coupling map 108. This can mean that the QML model 106 cannot be accurately executed on the quantum computing system 202(1) without change, without modification, and/or otherwise as originally trained. In other words, the quantum computing system 202(1) can be considered as inappropriate for the QML model 106.

As another example, if the similarity score 502(n) satisfies the threshold similarity value, it can be concluded that the coupling map 204(n) has the same (or sufficiently similar) arrangement of qubits and qubit-to-qubit connections, and/or has the same (or sufficiently similar) qubit properties and qubit-to-qubit connection properties, as the training coupling map 108. This can mean that the QML model 106 can be accurately executed on the quantum computing system 202(n) without change, without modification, and/or otherwise as originally trained. That is, the quantum computing system 202(n) can be considered as appropriate for the QML model 106. On the other hand, if the similarity score 502(n) fails to satisfy the threshold similarity value, it can be concluded that the coupling map 204(n) does not have the same (or sufficiently similar) arrangement of qubits and qubit-to-qubit connections, and/or does not have the same (or sufficiently similar) qubit properties and qubit-to-qubit connection properties, as the training coupling map 108. This can mean that the QML model 106 cannot be accurately executed on the quantum computing system 202(n) without change, without modification, and/or otherwise as originally trained. In other words, the quantum computing system 202(n) can be considered as inappropriate for the QML model 106.

FIG. 7 illustrates some non-limiting examples to help clarify such coupling map comparisons. As shown in FIG. 7, there can be a coupling map 701 made up of five qubits (e.g., qubit 706 to qubit 710) with four couplings, there can be a coupling map 702 made up of five qubits (e.g., qubit 711 to qubit 715) with four couplings, there can be a coupling map 703 made up of twenty qubits (e.g., qubit 716 to qubit 735) with twenty-three couplings, there can be a coupling map 704 made up of ten qubits (e.g., qubit 736 to qubit 745) with twelve couplings, and/or there can be a coupling map 705 made up of five qubits (e.g., qubit 746 to qubit 750) with six couplings.

In various aspects, when a similarity score is computed between the coupling map 701 and the coupling map 702, such similarity score can satisfy the threshold similarity score. That is, a subgraph matching metric computed between the coupling map 701 and the coupling map 702 can indicate a minimized (e.g., zero) distance separating the topology of the coupling map 701 from the topology of the coupling map 702. Thus, it can be concluded that: (i) the coupling map 701 topologically matches the coupling map 702; or (ii) the coupling map 701 topologically matches a subgraph of the coupling map 702. In the specific non-limiting example of FIG. 7, option (i) can be true (e.g., the coupling map 701 can have the same arrangement of qubits and qubit-to-qubit connections as the coupling map 702).

In various instances, when a similarity score is computed between the coupling map 701 and the coupling map 703, such similarity score can also satisfy the threshold similarity score. In other words, a subgraph matching metric computed between the coupling map 701 and the coupling map 703 can indicate a minimized (e.g., zero) distance separating the topology of the coupling map 701 from the topology of the coupling map 703. Thus, it can be concluded that: (i) the coupling map 701 topologically matches the coupling map 703; or (ii) the coupling map 701 topologically matches a subgraph of the coupling map 703. In the specific non-limiting example of FIG. 7, option (ii) can be true (e.g., the coupling map 701 can have the same arrangement of qubits and qubit-to-qubit connections as a subgraph of the coupling map 703, such as the subgraph given by the qubits 716, 717, 718, 722, and 721).

In various cases, when a similarity score is computed between the coupling map 701 and the coupling map 704, such similarity score can also satisfy the threshold similarity score. In other words, a subgraph matching metric computed between the coupling map 701 and the coupling map 704 can indicate a minimized (e.g., zero) distance separating the topology of the coupling map 701 from the topology of the coupling map 704. Thus, it can be concluded that: (i) the coupling map 701 topologically matches the coupling map 704; or (ii) the coupling map 701 topologically matches a subgraph of the coupling map 704. In the specific non-limiting example of FIG. 7, option (ii) can be true (e.g., the coupling map 701 can have the same arrangement of qubits and qubit-to-qubit connections as a subgraph of the coupling map 704, such as the subgraph given by the qubits 736, 737, 738, 741, and 742).

In contrast, when a similarity score is computed between the coupling map 701 and the coupling map 705, such similarity score can fail to satisfy the threshold similarity score. In other words, a subgraph matching metric computed between the coupling map 701 and the coupling map 705 can indicate a non-minimized (e.g., non-zero) distance separating the topology of the coupling map 701 from the topology of the coupling map 705. Thus, it can be concluded that: (iii) the coupling map 701 does not topologically match the coupling map 705; and (ii) the coupling map 701 does not topologically match any subgraph of the coupling map 705.

In any case, the map component 120 can generate the set of coupling map similarity scores 502 based on the quantum computing system vault 104 and/or based on the training coupling map 108. Note that, in various cases, the set of coupling map similarity scores 502 can be considered as respectively corresponding to the set of quantum computing systems 202. For example, the similarity score 502(1) can correspond to the coupling map 204(1), which can correspond to the quantum computing system 202(1). Likewise, the similarity score 502(n) can correspond to the coupling map 204(n), which can correspond to the quantum computing system 202(n).

Although the herein disclosure mainly describes various embodiments in which the map component 120 generates one similarity score per each of the set of quantum computing systems 202, this is a mere non-limiting example for ease of illustration/explanation. In various aspects, the map component 120 can refrain from generating a similarity score for one or more quantum computing systems in the set of quantum computing systems 202. For example, in some instances, the map component 120 can generate similarity scores only for those quantum computing systems that are currently available, that are not currently being executed, and/or that are not otherwise currently occupied. Conversely, the map component 120 can refrain from generating similarity scores for any quantum computing systems that are currently unavailable, that are currently being executed, and/or that are otherwise currently being occupied.

Note that, in some embodiments, some portion of a quantum computing system can be considered as currently available, as not currently being executed, and/or as not otherwise currently occupied, and some other portion of the quantum computing system can simultaneously be considered as currently unavailable, as currently being executed, and/or as otherwise currently occupied. For example, consider a quantum computing system that corresponds to the coupling map 703. Accordingly, such quantum computing system can be considered as having twenty qubits and twenty-three couplings. Suppose that a first subset of the twenty qubits of that quantum computing system are currently unavailable, currently being executed, and/or otherwise currently occupied, and further suppose that a remainder of the twenty qubits of that quantum computing system are currently available, not currently being executed, and/or not otherwise currently occupied. In such case, the map component 120 can ignore the first subset of that quantum computing system and can consider only the remainder of that quantum computing system, when computing a similarity score for that quantum computing system. For instance, suppose that seven of the twenty qubits of that quantum computing system are currently unavailable and that the remaining thirteen of the twenty qubits of that quantum computing system are currently available. In such case, when computing a similarity score for the coupling map 703, the map component 120 can ignore/disregard the seven qubits that are currently unavailable (and/or can ignore/disregard the couplings of those seven qubits). Instead, when computing a similarity score for the coupling map 703, the map component 120 can consider only the thirteen qubits that are currently available (and/or can consider the couplings of those thirteen qubits).

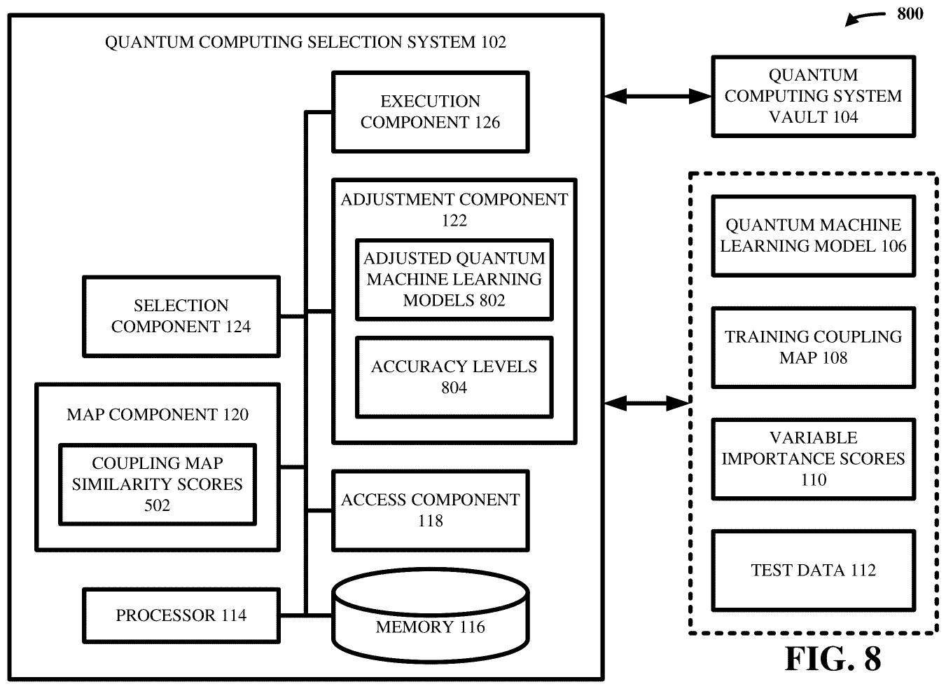

FIG. 8 illustrates a block diagram of an example, non-limiting system 800 including a set of adjusted quantum machine learning models and/or a set of accuracy levels that can facilitate quantum system selection via coupling map comparison in accordance with one or more embodiments described herein. As shown, the system 800 can, in some cases, comprise the same components as the system 500, and can further comprise a set of adjusted quantum machine learning models 802 (hereafter “set of adjusted QML models 802”) and/or a set of accuracy levels 804.

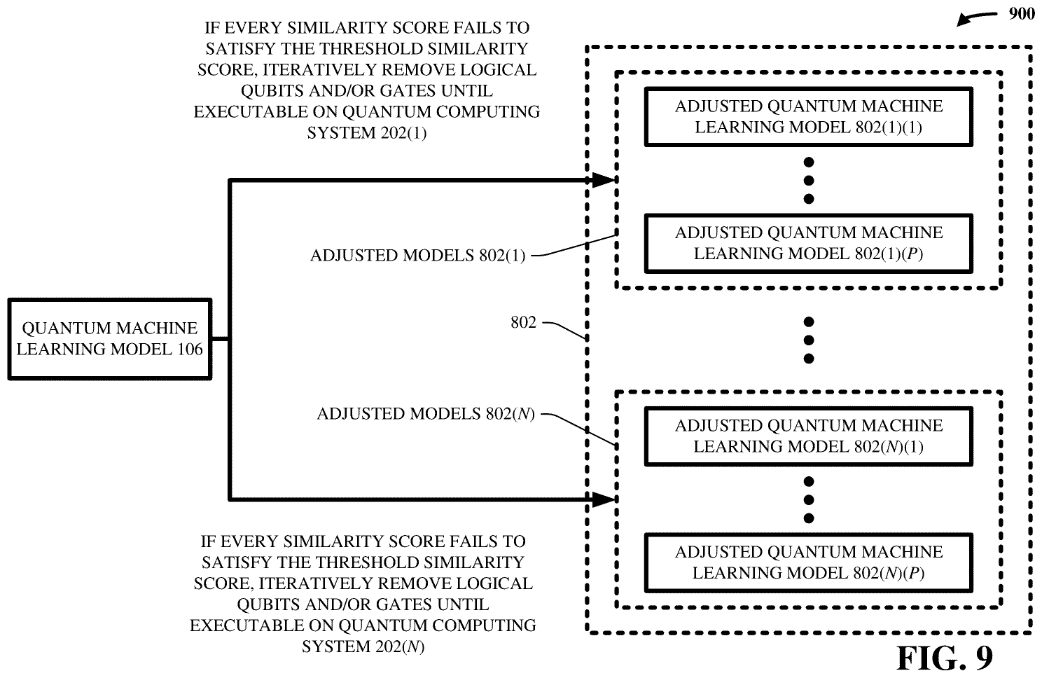

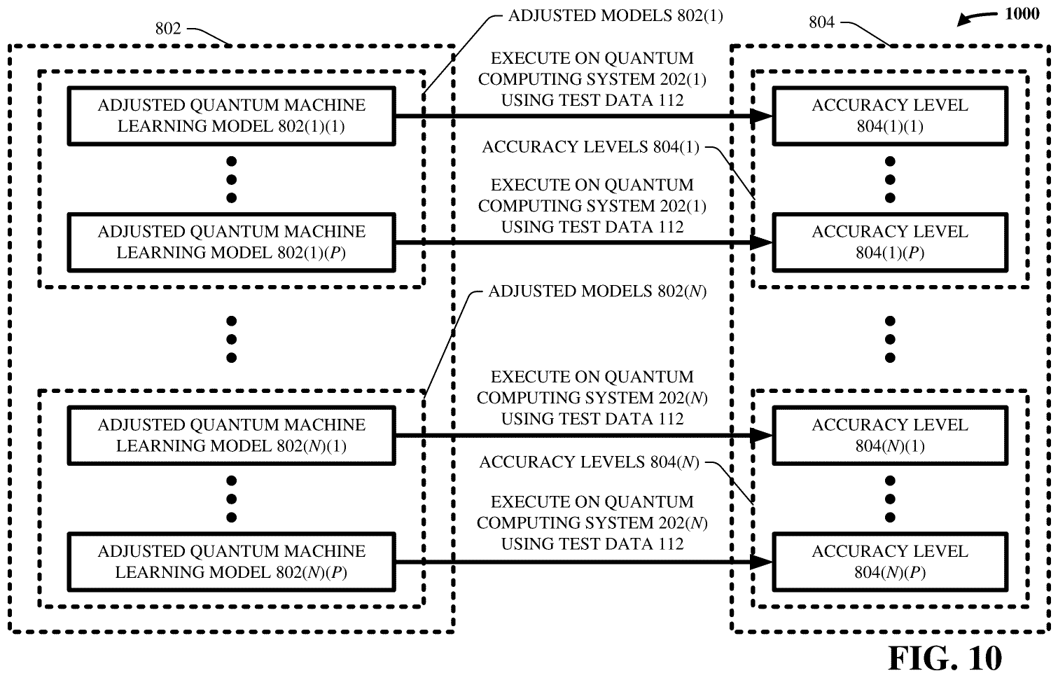

In various embodiments, in response to none of the set of coupling map similarity scores 502 satisfying the threshold similarity score (e.g., when the QML model 106 is properly executable on none of the set of quantum computing systems 202), the adjustment component 122 can electronically generate the set of adjusted QML models 802 and/or the set of accuracy levels 804, based on the set of variable importance scores 110 and/or based on the test data 112. This is further explained with respect to FIGS. 9-10.

FIG. 9 illustrates an example, non-limiting block diagram 900 showing how the set of adjusted QML models 802 can be generated in accordance with one or more embodiments described herein.

In various embodiments, as shown, when each of the set of coupling map similarity scores 502 fails to satisfy the threshold similarity score, the adjustment component 122 can electronically create one or more adjusted versions of the QML model 106 for each quantum computing system in the quantum computing system vault 104.

As a non-limiting example, the adjustment component 122 can generate, as described herein, a set of adjusted models 802(1) that are executable on the quantum computing system 202(1). In various instances, the set of adjusted models 802(1) can include p adjusted QML models for any suitable positive integer p: an adjusted QML model 802(1)(1) to an adjusted QML model 802(1)(p). In various aspects, each of such p adjusted QML models can be considered as an adjusted, edited, manipulated, and/or relaxed version of the QML model 106 that is supported by and/or otherwise executable on the quantum computing system 202(1).

In some cases, the adjustment component 122 can generate any of the set of adjusted models 802(1) using the following, non-limiting, example iterative procedure.

First, in various aspects, the adjustment component 122 can (A) create a copy of the QML model 106.

Next, in various instances, the adjustment component 122 can (B) remove (e.g., delete) from such copy whichever of the remaining quantum gates in the set of quantum gates 304 have lowest gate scores and/or whichever of the remaining logical qubits in the set of logical qubits 302 have lowest qubit scores. That is, at act (B), the adjustment component 122 can remove one or more quantum gates and/or one or more logical qubits from the copy of the QML model 106, in order of increasing variable importance score. However, this is a mere non-limiting example. In other embodiments, the adjustment component 122 can remove one or more quantum gates and/or one or more logical qubits from the copy of the QML model 106, in a random order. In any of these cases, the adjustment component 122 can generate a now-modified copy of the QML model 106, by removing/deleting quantum gates and/or logical qubits.

Subsequently, in various cases, the adjustment component 122 can (C) check whether such now-modified copy is executable on the quantum computing system 202(1). If the now-modified copy of the QML model 106 is not yet executable on the quantum computing system 202(1), the adjustment component 122 can proceed back to act (B). On the other hand, if the now-modified copy of the QML model 106 is executable on the quantum computing system 202(1), the adjustment component 122 can record/log such now-modified copy of the QML model 106 in the set of adjusted models 802(1).

In various embodiments, the adjustment component 122 can perform the check specified in act (C) (e.g., can check whether the now-modified copy is executable on the quantum computing system 202(1)) by any suitable technique.

As a non-limiting example, the adjustment component 122 can perform such check by attempting to execute the now-modified copy of the QML model 106 on the quantum computing system 202(1). If such attempted execution is unsuccessful (e.g., if the quantum computing system 202(1) returns at least one compilation error and/or at least one runtime error in response to such attempted execution), the adjustment component 122 can infer/determine that the now-modified copy of the QML model 106 is not yet executable on the quantum computing system 202(1). On the other hand, if such attempted execution is successful (e.g., if the quantum computing system 202(1) does not return at least one compilation error and/or at least one runtime error in response to such attempted execution), the adjustment component 122 can instead infer/determine that the now-modified copy of the QML model 106 is executable on the quantum computing system 202(1).

As another non-limiting example, the adjustment component 122 can perform the check specified in act (C) by: modifying the training coupling map 108 commensurately with the QML model 106; and computing a new similarity score between the coupling map 204(1) and such modified version of the training coupling map 108.

For instance, as mentioned above, the adjustment component 122 can create the now-modified copy of the QML model 106 by removing, at act (B), one or more quantum gates and/or one or more logical qubits. In various aspects, after removal of such quantum gates and/or logical qubits, it can be possible that there are one or more specific qubits and/or one or more specific qubit-to-qubit connections in the training coupling map 108 that are no longer being utilized by the now-modified version of the QML model 106. In other words, there can be specific qubits and/or specific qubit-to-qubit connections in the training coupling map 108 on which none of the remaining quantum gates of the now-modified version of the QML model 106 are performed. In still other words, removal of quantum gates and/or logical qubits from the QML model 106 at act (B) can render unused those specific qubits and/or those specific qubit-to-qubit connections of the training coupling map 108. Accordingly, in various aspects, the adjustment component 122 can remove those specific, now-unused qubits and/or those specific, now-unused qubit-to-qubit connections from the training coupling map 108, thereby yielding a modified-version of the training coupling map 108.

In this way, the adjustment component 122 can generate a modified version of the training coupling map 108 that is commensurate with the now-modified copy of the QML model 106. In various aspects, the map component 120 can compute a new similarity score, as described above, between the modified version of the training coupling map 108 and the coupling map 204(1). If such new similarity score satisfies the threshold similarity score (e.g., if the modified version of the training coupling map 108 topologically matches the coupling map 204(1) or topologically matches any subgraph of the coupling map 204(1)), then the adjustment component 122 can infer/determine that the now-modified copy of the QML model 106 is executable on the quantum computing system 202(1). In contrast, if such new similarity score fails to satisfy the threshold similarity score (e.g., if the modified version of the training coupling map 108 does not topologically match the coupling map 204(1) and does not topologically match every subgraph of the coupling map 204(1)), then the adjustment component 122 can instead conclude that the now-modified copy of the QML model 106 is not yet executable on the quantum computing system 202(1).

As another non-limiting example, the adjustment component 122 can generate, as described herein, a set of adjusted models 802(n) that are executable on the quantum computing system 202(n). In various instances, the set of adjusted models 802(n) can include p adjusted QML models for any suitable positive integer p: an adjusted QML model 802(n)(1) to an adjusted QML model 802(n)(p). Just as above, each of such p adjusted QML models can be considered as an adjusted, edited, manipulated, and/or relaxed version of the QML model 106 that is supported by and/or otherwise executable on the quantum computing system 202(n).

In some cases, and similar to as described above, the adjustment component 122 can generate any of the set of adjusted models 802(n) using the following, non-limiting, example iterative procedure.

First, and just as above, the adjustment component 122 can (A) create a copy of the QML model 106.

Next, and just as above, the adjustment component 122 can (B) remove from such copy one or more quantum gates and/or one or more logical qubits, either in order of increasing variable importance score or in a random order. In any case, the adjustment component 122 can generate a now-modified copy of the QML model 106, by removing/deleting quantum gates and/or logical qubits.

Subsequently, in various cases, the adjustment component 122 can (C′) check whether such now-modified copy is executable on the quantum computing system 202(n). If the now-modified copy of the QML model 106 is not yet executable on the quantum computing system 202(n), the adjustment component 122 can proceed back to act (B). On the other hand, if the now-modified copy of the QML model 106 is executable on the quantum computing system 202(n), the adjustment component 122 can record/log such now-modified copy of the QML model 106 in the set of adjusted models 802(n).

Similar to as described above, the adjustment component 122 can perform the check specified in act (C′) (e.g., can check whether the now-modified copy is executable on the quantum computing system 202(n)) by any suitable technique. As a non-limiting example, the adjustment component 122 can perform such check by attempting to execute the now-modified copy of the QML model 106 on the quantum computing system 202(n). As another non-limiting example, the adjustment component 122 can perform such check by: modifying the training coupling map 108 commensurately with the QML model 106 (e.g., by removing from the training coupling map 108 any qubits and/or qubit-to-qubit connections that are no longer being utilized by an adjusted version of the QML model 106); and computing a new similarity score between the coupling map 204(n) and such modified version of the training coupling map 108.

In any case, the adjustment component 122 can generate one or more adjusted versions of the QML model 106 for each of the quantum computing systems in the quantum computing system vault 104. In various aspects, the adjusted QML model 802(1)(1) to the adjusted QML model 802(n)(p) can be collectively considered as the set of adjusted QML models 802.

Although FIG. 9 shows the set of adjusted models 802(n) as having the same number of models (e.g., p) as the set of adjusted models 802(1), this is a mere non-limiting example for ease of illustration. In various aspects, the set of adjusted models 802(n) can have a different number of models than the set of adjusted models 802(1) (e.g., different quantum computing systems can correspond to the same and/or different numbers of adjusted QML models as each other).

FIG. 10 illustrates an example, non-limiting block diagram 1000 showing how the set of accuracy levels 804 can be generated in accordance with one or more embodiments described herein.

In various embodiments, the set of accuracy levels 804 can be a set of real-valued scalars that respectively correspond (e.g., in one-to-one fashion) to the set of adjusted QML models 802. In other words, the adjustment component 122 can compute and/or calculate an accuracy level for each of the set of adjusted QML models 802. In some cases, the adjustment component 122 can compute/calculate such accuracy levels based on the test data 112.

For example, an accuracy level 804(1)(1) can be a real-valued scalar whose magnitude indicates/represents how well (e.g., how accurately, how precisely) the adjusted QML model 802(1)(1) can perform. In various aspects, the adjustment component 122 can compute the accuracy level 804(1)(1) by: (I) selecting an inputted quantum state and a corresponding outputted quantum state from the test data 112; (II) initializing the quantum computing system 202(1) with the selected inputted quantum state; (III) executing the adjusted QML model 802(1)(1) on the quantum computing system 202(1) after such initialization, such that the adjusted QML model 802(1)(1) produces a resultant quantum state; (IV) computing a difference between the resultant quantum state and the selected outputted quantum state; (V) repeating (I)-(IV) for all k pairs of inputted quantum states and outputted quantum states in the test data 112, thereby yielding a total of k computed differences; and/or (VI) calculating the accuracy level 804(1)(1) based on such k computed differences. In various cases, the accuracy level 804(1)(1) can be equal to and/or otherwise based on an average/mean of such k computed differences. In various aspects, (I)-(IV) can be considered as performing a test run of the adjusted QML model 802(1)(1) on the quantum computing system 202(1) using the test data 112, and/or (I)-(V) can be considered as performing k test runs of the adjusted QML model 802(1)(1) on the quantum computing system 202(1) using the test data 112.

As another example, an accuracy level 804(1)(p) can be a real-valued scalar whose magnitude indicates/represents how well (e.g., how accurately, how precisely) the adjusted QML model 802(1)(p) can perform. Just like above, the adjustment component 122 can compute the accuracy level 804(1)(p) by: conducting k test runs of the adjusted QML model 802(1)(p) on the quantum computing system 202(1) using the test data 112, thereby yielding a set of k computed differences; and calculating the accuracy level 804(1)(p) based on such k computed differences. In various cases, the accuracy level 804(1)(1) to the accuracy level 804(1)(p) can be referred to as a set of accuracy levels 804(1).

As yet another example, an accuracy level 804(n)(1) can be a real-valued scalar whose magnitude indicates/represents how well (e.g., how accurately, how precisely) the adjusted QML model 802(n)(1) can perform. Just like above, the adjustment component 122 can compute the accuracy level 804(n)(1) by: conducting k test runs of the adjusted QML model 802(n)(1) on the quantum computing system 202(n) using the test data 112, thereby yielding a set of k computed differences; and calculating the accuracy level 804(n)(1) based on such k computed differences.

As even another example, an accuracy level 804(n)(p) can be a real-valued scalar whose magnitude indicates/represents how well (e.g., how accurately, how precisely) the adjusted QML model 802(n)(p) can perform. Just like above, the adjustment component 122 can compute the accuracy level 804(n)(p) by: conducting k test runs of the adjusted QML model 802(n)(p) on the quantum computing system 202(n) using the test data 112, thereby yielding a set of k computed differences; and calculating the accuracy level 804(n)(p) based on such k computed differences. In various cases, the accuracy level 804(n)(1) to the accuracy level 804(n)(p) can be referred to as a set of accuracy levels 804(n).

In various aspects, accuracy scores can be calculated on unoccupied/available quantum computing systems and/or that accuracy scores cannot be calculated on occupied/unavailable quantum computing systems (e.g., a test run cannot be implemented/executed on a currently occupied quantum computing system).

In any case, the adjustment component 122 can leverage the test data 112 to calculate an accuracy score for each adjusted version of the QML model 106.

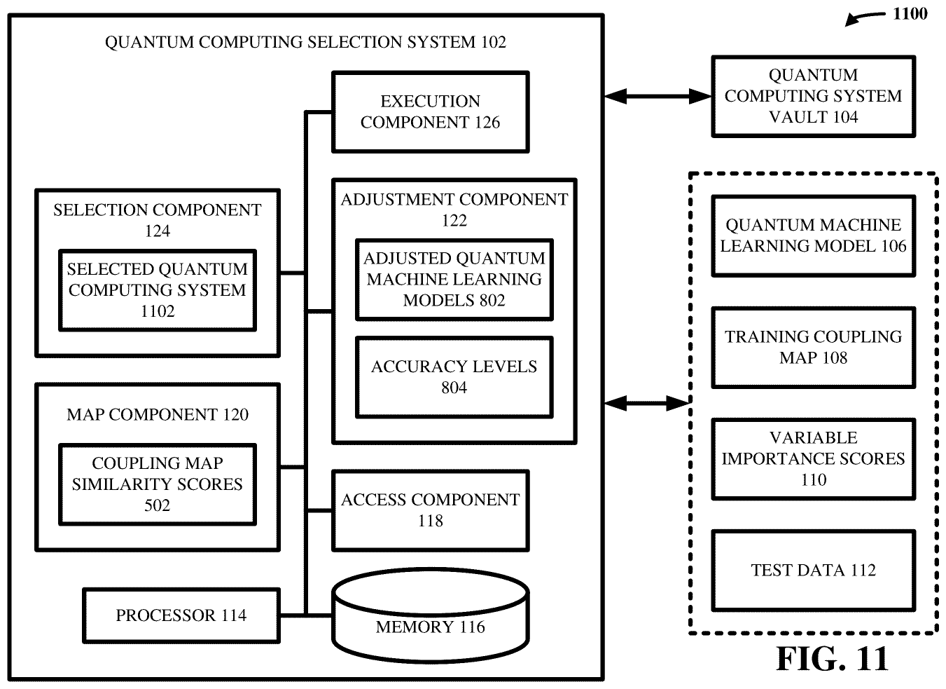

FIG. 11 illustrates a block diagram of an example, non-limiting system 1100 including a selected quantum computing system that can facilitate quantum system selection via coupling map comparison in accordance with one or more embodiments described herein. As shown, the system 1100 can, in some cases, comprise the same components as the system 800, and can further comprise a selected quantum computing system 1102.

In various embodiments, the selection component 124 can electronically select, choose, and/or identify one of the set of quantum computing systems 202 as being appropriate for the QML model 106 (and/or as being appropriate for an adjusted version of the QML model 106), based on the set of coupling map similarity scores 502 and/or based on the set of accuracy levels 804. In any case, such selected, chosen, and/or identified quantum computing system can be referred to as the selected quantum computing system 1102.

As a non-limiting example, the selected quantum computing system 1102 can be whichever of the set of quantum computing systems 202 has a coupling map similarity score that satisfies the threshold similarity score. If more than one such quantum computing system exists, then the selection component 124 can select/choose from among such more than one quantum computing systems according to any suitable order of priority. For instance, the selected quantum computing system 1102 can be whichever of such more than one quantum computing systems is currently available, is not currently occupied, and/or has a lowest queue time. In other cases, the selected quantum computing system 1102 can be whichever of such more than one quantum computing systems has the smallest number of qubits. In still other cases, the selected quantum computing system 1102 can be whichever of such more than one quantum computing systems is associated with highest qubit fidelities, highest qubit coherence times, lowest qubit noise levels, and/or lowest qubit error rates. In even other cases, the selected quantum computing system 1102 can be whichever of such more than one quantum computing systems is associated with a lowest, cheapest, and/or least expensive monetary cost (e.g., a smallest monetary price per hour to use/occupy the quantum computing system).

In various embodiments, the execution component 126 can electronically generate and/or transmit (e.g., to any suitable computing device, not shown) an electronic message, where such electronic message can indicate that the selected quantum computing system 1102 is appropriate for the QML model 106. That is, the electronic message can indicate that the QML model 106 is accurately executable on and/or otherwise supported by the selected quantum computing system 1102. In some cases, the electronic message can further indicate any other suitable information pertaining to the selected quantum computing system 1102 (e.g., a queue time associated with the selected quantum computing system 1102; qubit noise levels associated with the selected quantum computing system 1102; qubit fidelities associated with the selected quantum computing system 1102).

In various other embodiments, the execution component 126 can electronically execute the QML model 106 on the selected quantum computing system 1102. More specifically, the execution component 126 can: initialize the selected quantum computing system 1102 with any suitable user-provided quantum state initialization; and/or execute, after such initialization, the QML model 106 on the selected quantum computing system 1102, thereby yielding a resultant quantum state. In some cases, the execution component 126 can electronically share the resultant quantum state with any other suitable computing device.

As another non-limiting example, when none of the set of coupling map similarity scores 502 satisfy the threshold similarity score, the selection component 124 can identify which of the set of adjusted QML models 802 has a highest/best accuracy level, and the selected quantum computing system 1102 can be whichever of the set of quantum computing systems 202 corresponds to (e.g., has been checked by the adjustment component 122 as being able to execute) such adjusted version of the QML model 106. Just as above, if more than one such quantum computing system exists, then the selection component 124 can select/choose from among such more than one quantum computing systems according to any suitable order of priority (e.g., according to availability and/or queue time, according to qubit fidelity, according to qubit noise level and/or qubit error rate).

In various embodiments, the execution component 126 can electronically generate and/or transmit (e.g., to any suitable computing device, not shown) an electronic message, where such electronic message can indicate that none of the set of quantum computing systems 202 are appropriate for the QML model 106 (e.g., for the original, unaltered version of the QML model 106). In various aspects, however, the electronic message can further indicate that the selected quantum computing system 1102 is appropriate for the adjusted version of the QML model 106 that has the highest/best accuracy level. Just as above, the electronic message can further indicate any other suitable information pertaining to the selected quantum computing system 1102 (e.g., a queue time associated with the selected quantum computing system 1102; qubit noise levels associated with the selected quantum computing system 1102; qubit fidelities associated with the selected quantum computing system 1102).

In yet other cases, the electronic message can instead indicate multiple of such set of quantum computing systems 202, the multiple adjusted QML models that correspond to such multiple quantum computing systems, and/or the accuracy levels of such multiple adjusted QML models. For example, the execution component 126 can, in various aspects, identify x (for any suitable positive integer x<n) quantum computing systems from the set of quantum computing systems 202. In various aspects, some of such x quantum computing systems can correspond to the QML model 106 itself (e.g., to the original, unaltered version of the QML model 106), and others of such x quantum computing systems can correspond to different adjusted versions of the QML model 106 (e.g., to the top and/or most accurate adjusted versions of the QML model 106). In such cases, the accuracy levels (and/or any other information, such as coherence times, error rates, noise levels, and/or monetary cost) of such x quantum computing systems can be transmitted, rendered, and/or conveyed by the execution component 126.

In various other embodiments, the execution component 126 can electronically execute on the selected quantum computing system 1102 whichever adjusted version of the QML model corresponds to the selected quantum computing system 1102. That is, just as above, the execution component 126 can: initialize the selected quantum computing system 1102 with any suitable user-provided quantum state initialization; and/or execute, after such initialization, the adjusted version of the QML model 106 on the selected quantum computing system 1102, thereby yielding a resultant quantum state. Again, in some cases, the execution component 126 can electronically share the resultant quantum state with any other suitable computing device.

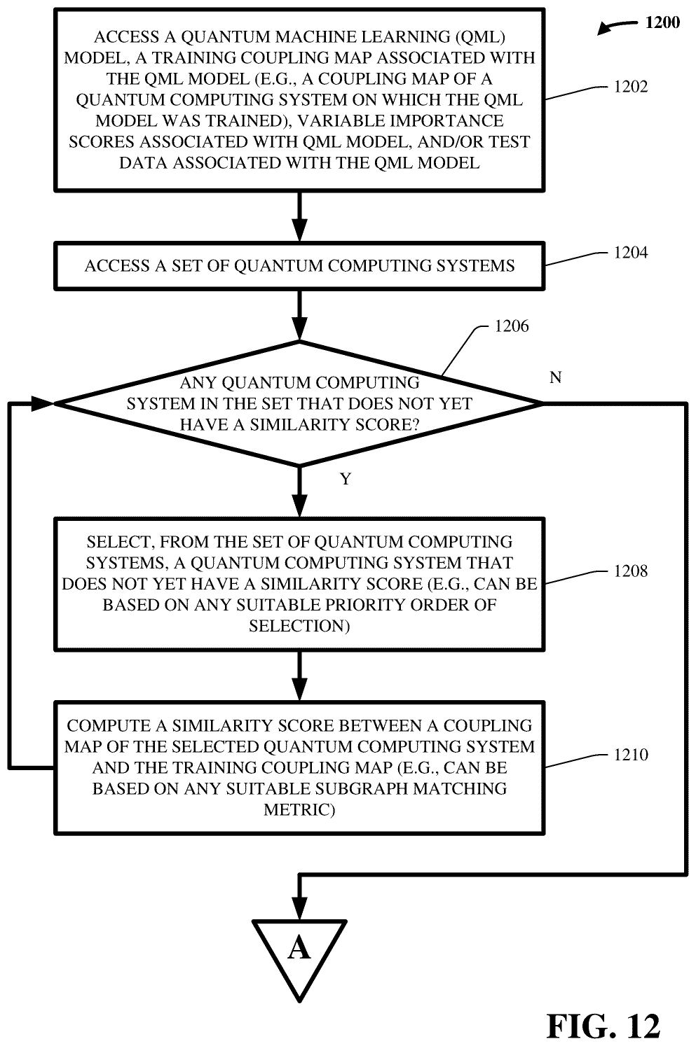

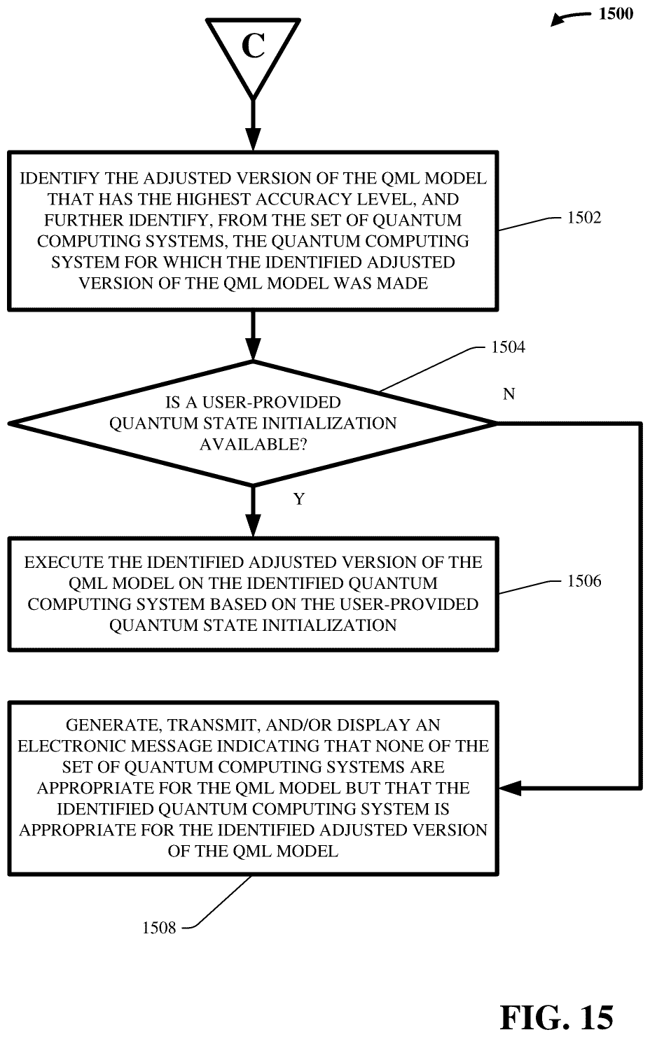

FIGS. 12-15 illustrate flow diagrams of example, non-limiting computer-implemented methods 1200, 1300, 1400, and 1500 that can facilitate quantum system selection via coupling map comparison in accordance with one or more embodiments described herein. In various cases, the quantum computing selection system 102 can facilitate the computer-implemented methods 1200, 1300, 1400, and/or 1500.

First, consider FIG. 12. In various embodiments, act 1202 can include accessing, by a device (e.g., via 118) operatively coupled to a processor, a QML model (e.g., 106), a training coupling map (e.g., 108) associated with the QML model, variable importance scores (e.g., 110) associated with the QML model, and/or test data (e.g., 112) associated with the QML model. In some cases, as mentioned above, the training coupling map can show a connectivity topology of the specific quantum computing system on which the QML model was trained.

In various aspects, act 1204 can include accessing, by the device (e.g., via 118), a set of quantum computing systems (e.g., 202).

In various instances, act 1206 can include determining, by the device (e.g., via 120), whether any quantum computing system in the set does not yet have a coupling map similarity score. If not (e.g., if every quantum computing system already has a coupling map similarity score), the computer-implemented method 1200 can proceed to act 1302 of the computer-implemented method 1300. On the other hand, if so (e.g., if at least one quantum computing system does not yet have a coupling map similarity score), the computer-implemented method 1200 can proceed to act 1208.

In various cases, act 1208 can include selecting, from the set of quantum computing systems, a quantum computing system that does not yet have a coupling map similarity score. In various aspects, this can be based on any suitable priority order of selection (e.g., availability, queue times, qubit count, fidelity, noise levels, error rates).

In various instances, act 1210 can include computing, by the device (e.g., via 120), a coupling map similarity score (e.g., one of 502) between a coupling map (e.g., one of 204) of the selected quantum computing system (e.g., selected at 1208) and the training coupling map. In various cases, this can be based on any suitable subgraph matching metric, such as Gromov-Hausdorff distance, Manhattan distance, graph edit distance, and/or Min/Max similarity measure. As shown, the computer-implemented method 1200 can proceed back to act 1206.

Note that, in some cases, the device can have previously computed one or more coupling map similarity scores for one or more quantum computing systems in the set, and such one or more coupling map similarity scores can be electronically stored/recorded in a computerized memory. In such cases, such previously-calculated coupling map similarity scores can be recalled and/or queried, without having to be re-computed by the device (e.g., the device need not iterate through acts 1208-1210 for such quantum computing systems). However, even if a given quantum computing system does have a previously-calculated coupling map similarity score, the device can re-calculate the coupling map similarity score (e.g., can iterate through acts 1208 and 1210) for such given quantum computing system, if the given quantum computing system has been changed/updated since that previous coupling map similarity score was calculated (e.g., if the total number of qubits and/or the qubit topology of that given quantum computing system were changed/updated, if the qubit properties and/or qubit-to-qubit connection properties of that given quantum computing system were changed/updated), and/or if the QML model was retrained on a different quantum computing system since that previous coupling map similarity score was calculated.

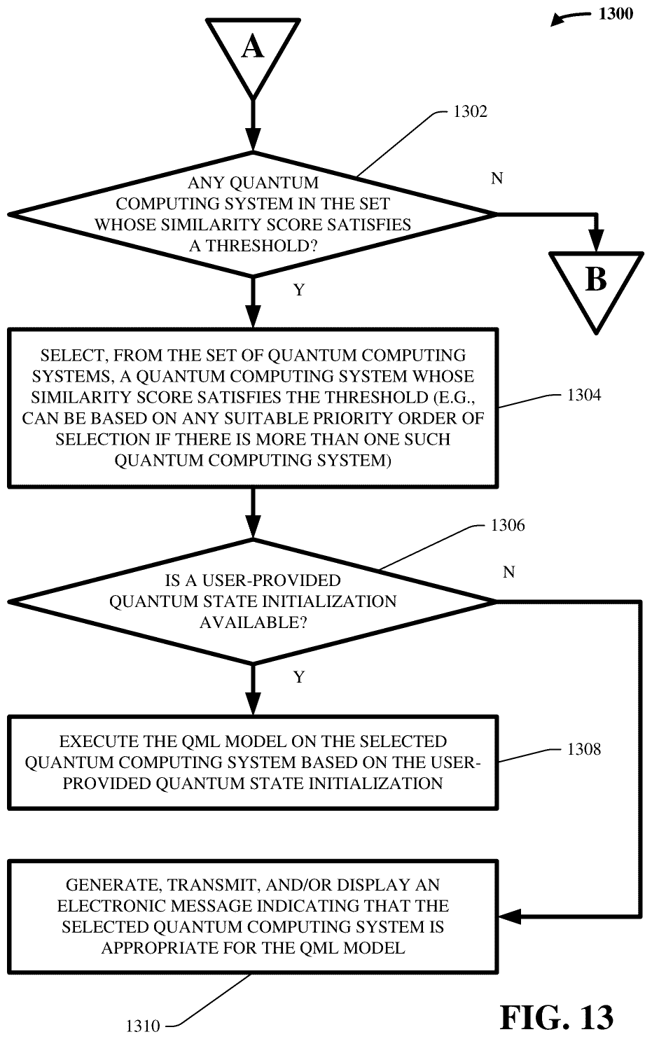

Now, consider FIG. 13. In various embodiments, act 1302 can include determining, by the device (e.g., via 124), whether any quantum computing system in the set has a coupling map similarity score that satisfies a threshold (e.g., the above-described threshold similarity score). As explained above, such threshold can be equal to and/or otherwise based on whatever similarity score value/magnitude indicates a minimized and/or otherwise pre-defined subgraph matching metric. If no coupling map similarity score satisfies the threshold, the computer-implemented method 1300 can proceed to act 1402 of the computer-implemented method 1400. On the other hand, if at least one coupling map similarity score satisfies the threshold, the computer-implemented method 1300 can proceed to act 1304.

In various aspects, act 1304 can include selecting, by the device (e.g., via 124) and from the set of quantum computing systems, a quantum computing system (e.g., 1102) whose coupling map similarity score satisfies the threshold. In various instances, such selection can be based on any suitable order of priority when there is more than one such quantum computing system (e.g., based on availability, queue time, qubit count, fidelities, noise levels, error rates).

In various cases, act 1306 can include determining, by the device (e.g., via 126), whether a user-provided quantum state initialization is available and/or has otherwise been received/imported. If not, the computer-implemented method 1300 can proceed to act 1310. On the other hand, if so, the computer-implemented method 1300 can proceed to act 1308.

In various aspects, act 1308 can include executing, by the device (e.g., via 126), the QML model on the selected quantum computing system (e.g., selected at 1304) based on the user-provided quantum state initialization.

In various instances, act 1310 can include generating, transmitting, and/or displaying, by the device (e.g., via 126), an electronic message indicating that the selected quantum computing system (e.g., selected at 1304) is appropriate for the QML model. That is, the electronic message can indicate that the QML model can be executed on and/or is otherwise supported by the selected quantum computing system.

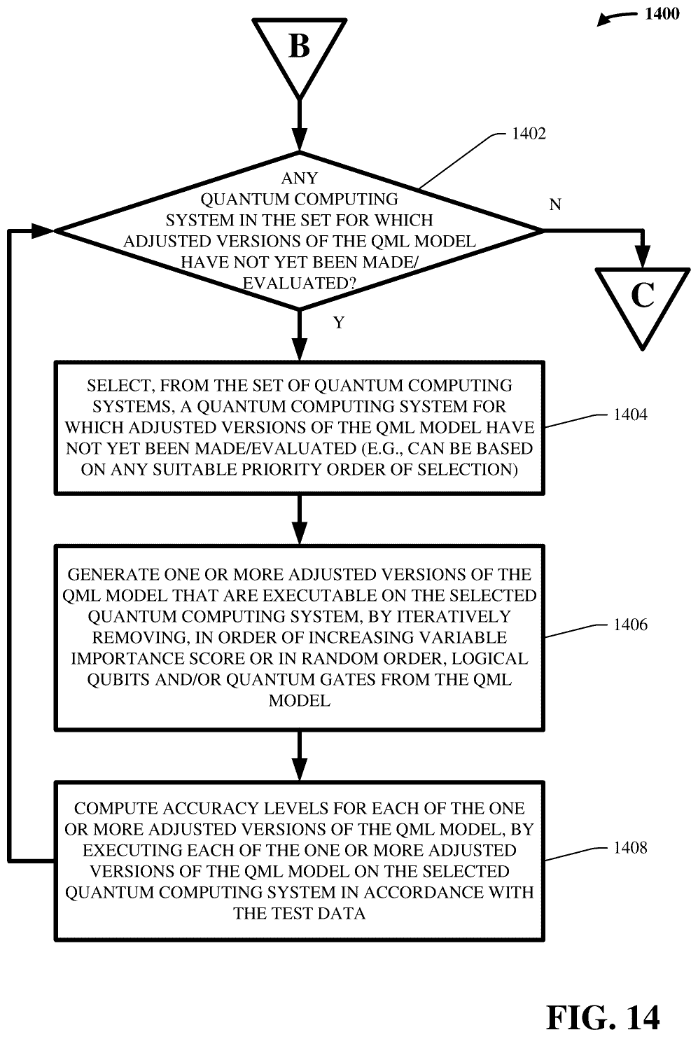

Now, consider FIG. 14. In various embodiments, act 1402 can include determining, by the device (e.g., via 122), whether there is any quantum computing system in the set for which adjusted versions of the QML model have not yet been made and/or evaluated. If not (e.g., if adjusted versions of the QML model have been made/evaluated for every quantum computing system in the set), the computer-implemented method 1400 can proceed to act 1502 of the computer-implemented method 1500. On the other hand, if so (e.g., if there is at least one quantum computing system in the set for which adjusted versions of the QML model have not yet been made/evaluated), the computer-implemented method 1400 can proceed to act 1404.

In various aspects, act 1404 can include selecting, by the device (e.g., via 122) and from the set of quantum computing systems, a quantum computing system for which adjusted versions of the QML model have not yet been made/evaluated. In various instances, such selection can be based on any suitable order of priority (e.g., can be in order of decreasing coupling map similarity score).

In various instances, act 1406 can include generating, by the device (e.g., via 122), one or more adjusted versions of the QML model (e.g., the set of adjusted models 802(n)) that are executable on the selected quantum computing system (e.g., selected at 1404). In various cases, this can be facilitated by iteratively removing, in order of increasing variable importance score and/or in random order, logical qubits and/or quantum gates from the QML model.

In various aspects, act 1408 can include computing, by the device (e.g., via 122), accuracy levels (e.g., the set of accuracy levels 804(n)) for each of the one or more adjusted versions of the QML model. In various cases, this can be facilitated by executing each of the one or more adjusted versions of the QML model on the selected quantum computing system (e.g., selected at 1404) in accordance with the test data. In various cases, as shown, the computer-implemented method 1400 can proceed back to act 1402.

Note that, in some cases, the device can have previously generated one or more adjusted versions of the QML model for any particular quantum computing system in the set, and such one or more adjusted versions can be electronically stored/recorded in a computerized memory. In such cases, such one or more previously-generated adjusted versions of the QML model can be recalled and/or queried, without having to be re-generated from scratch by the device (e.g., the device need not iterate through acts 1404-1408 for such quantum computing systems). However, even if a given quantum computing system does correspond to a previously-generated adjusted version of the QML model, the device can re-generate the adjusted version of the QML model (e.g., can iterate through acts 1404-1408) for such given quantum computing system, if the given quantum computing system was changed/updated since that previous adjusted version of the QML model was generated (e.g., if the total number of qubits and/or the qubit topology of that given quantum computing system were changed/updated, and/or if the qubit properties and/or qubit-to-qubit connection properties of that given quantum computing system were changed/updated), and/or if the QML model was retrained on a different quantum computing system since that previous adjusted version was generated.

Now, consider the computer-implemented method 1500. In various embodiments, act 1502 can include identifying, by the device (e.g., via 124), the adjusted version of the QML model (e.g., one of 802) that has the highest and/or best accuracy level (e.g., one of 804). In various aspects, act 1502 can further include identifying, by the device (e.g., via 124) and from the set of quantum computing systems, the quantum computing system (e.g., 1102) for which the identified adjusted version of the QML model was made (e.g., the quantum computing system that can support and/or execute the identified adjusted version of the QML model). Such identification/selection can be based on any suitable order of priority when there is more than one such quantum computing system (e.g., based on availability, queue time, qubit count, fidelities, noise levels, error rates).

In various instances, act 1504 can include determining, by the device (e.g., via 126), whether a user-provided quantum state initialization is available and/or has otherwise been received/imported. If not, the computer-implemented method 1500 can proceed to act 1508. On the other hand, if so, the computer-implemented method 1500 can proceed to act 1506.

In various aspects, act 1506 can include executing, by the device (e.g., via 126), the identified adjusted version of the QML model on the identified quantum computing system (e.g., identified at 1502) based on the user-provided quantum state initialization.

In various instances, act 1508 can include generating, transmitting, and/or displaying, by the device (e.g., via 126), an electronic message indicating that none of the set of quantum computing systems are appropriate for the QML model, but also indicating that the identified quantum computing system (e.g., identified at 1502) is appropriate for the identified adjusted version of the QML model. That is, the electronic message can indicate that the identified adjusted version of the QML model can be executed on and/or is otherwise supported by the identified quantum computing system.

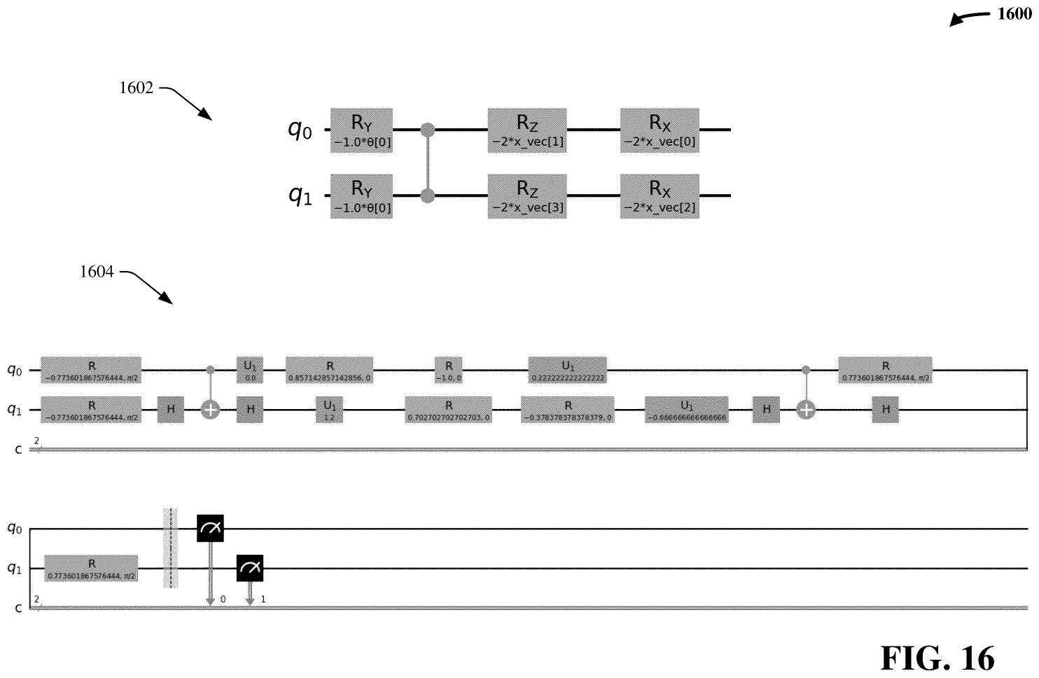

FIGS. 16-18 illustrate block diagrams 1600, 1700, and 1800 of example, non-limiting experimental results in accordance with one or more embodiments described herein.

Specifically, the present inventors considered a binary classification problem that involved four input features (e.g., sepal length, sepal width, petal length, petal width) and two output classes (e.g., versicolor class and virginica class). In various aspects, a QML model was created to evaluate such binary classification problem. In particular, a feature map, shown by numeral 1602 of FIG. 16, was crafted, and such feature map was converted into a kernel calculating circuit, shown by numeral 1604 of FIG. 16, via an inversion test. In various cases, such kernel calculating circuit can be considered as the QML model. In various aspects, such kernel calculating circuit was executed on a known test dataset, and the kernel calculating circuit achieved an accuracy score of 97%.

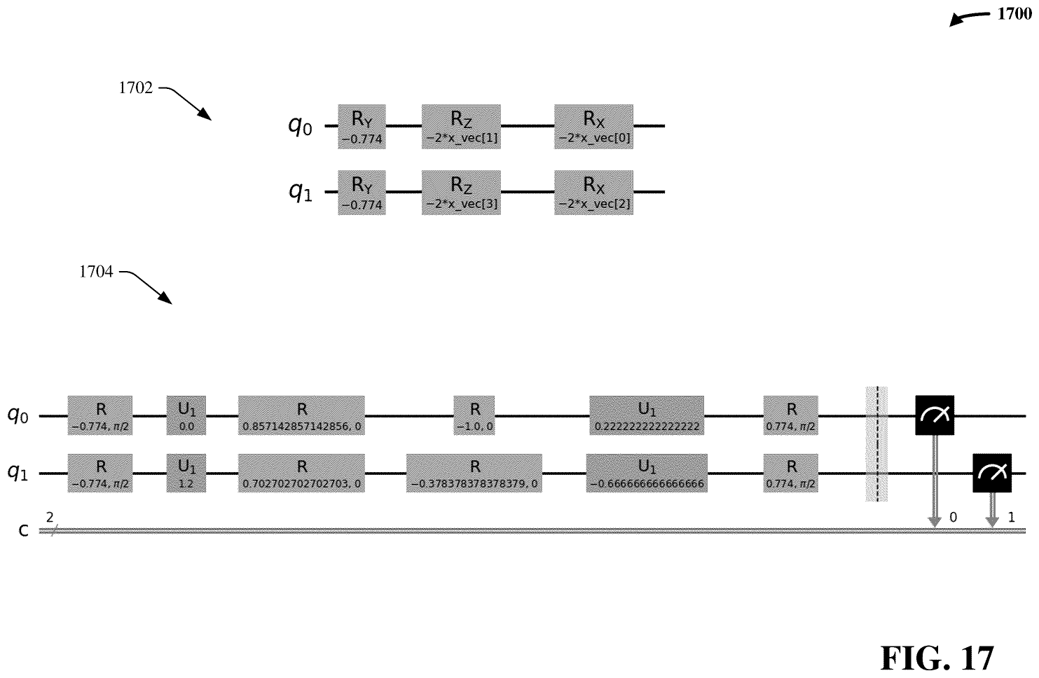

In various instances, the Control-Z gate was removed from the feature map, as shown by numeral 1702 of FIG. 17. Application of the inversion test to such adjusted feature map yielded the kernel calculating circuit shown by numeral 1704 of FIG. 17. Such kernel calculating circuit was executed on the known test dataset, yielding an accuracy score of 97%.

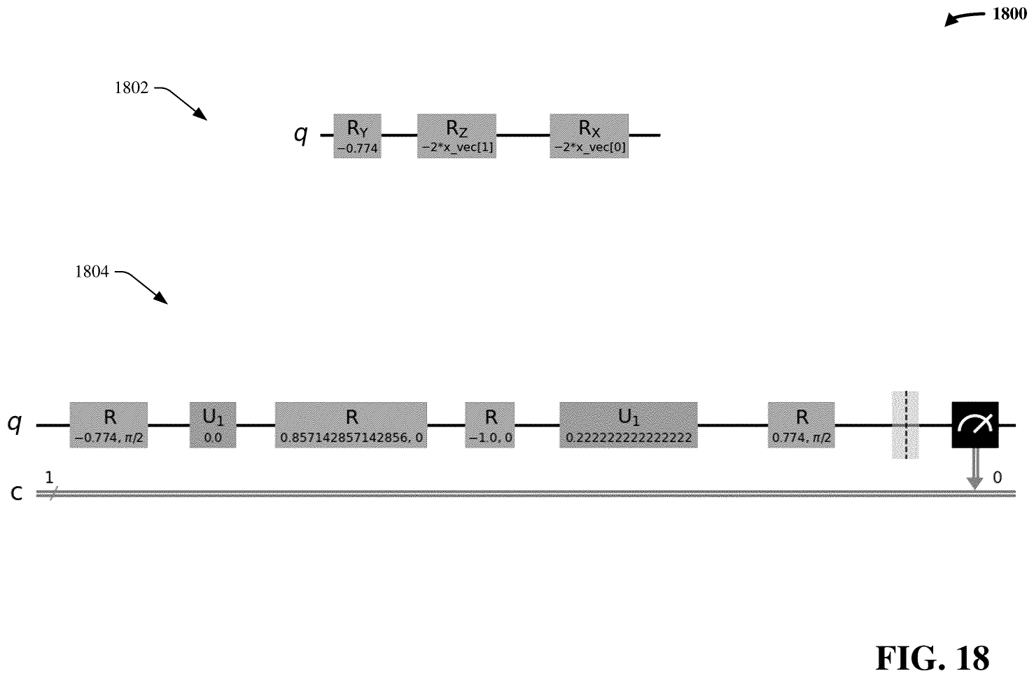

In various other instances, the second qubit was removed from the feature map, as shown by numeral 1802 of FIG. 18. Application of the inversion test to such adjusted feature map yielded the kernel calculating circuit shown by numeral 1804 of FIG. 18. Such kernel calculating circuit was executed on the known test dataset, yielding an accuracy score of 62%.

These experimental results help to validate the functionality/performance of the adjustment component 122. In other words, the present inventors realized that there can often be a non-zero amount of redundancy in the parameter settings of a QML model, such that the QML model can still exhibit sufficient accuracy even after removal of some quantum gates and/or of some logical qubits. Indeed, as shown in the above non-limiting example, removal of the Controlled-Z gate did not affect the accuracy of the QML model, whereas removal of the second qubit still allowed the QML model to have a better than random (e.g., better than coin-toss) accuracy. The training and execution that led to this accuracy score was performed on a single quantum system.

In various cases, a user can be provided with these results and can decide which of such adjusted models to run/execute. For example, it can be the case that the quantum computer that was used to train and/or run the kernel 1604 is unavailable. It can further be the case that a quantum computer capable of running the kernel 1704 is also unavailable. However, it can be the case that a quantum computer capable of running the kernel 1804 is available. In such instance, the user can decide whether or not an accuracy rate of 62% is sufficient to warrant execution of the kernel 1804. If 62% is sufficiently high in the opinion of the user (e.g., the model can be involved in a low-importance field/context where high accuracy is not paramount), the user can decide to execute the kernel 1804 now on the available quantum computer. On the other hand, if 62% is not sufficiently high in the opinion of the user (e.g., the model can be involved in a high-importance field/context where high accuracy is paramount), the user can decide to refrain from executing the kernel 1804 and can instead opt to wait in a queue for a quantum computer that is capable of executing the kernel 1604 and/or the kernel 1704.

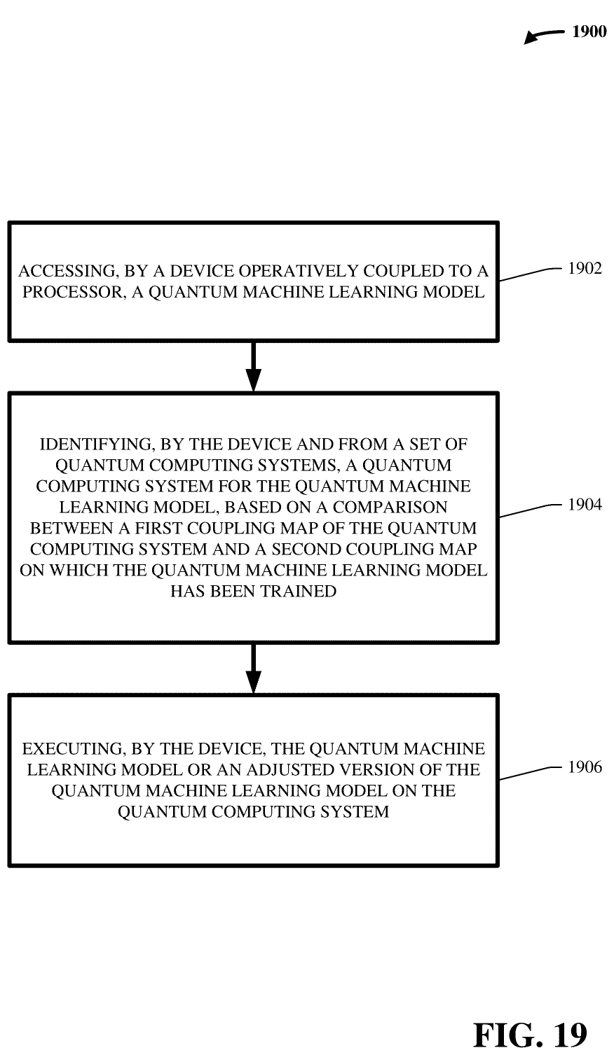

FIG. 19 illustrates a flow diagram of an example, non-limiting computer-implemented method 1900 that can facilitate quantum system selection via coupling map comparison in accordance with one or more embodiments described herein. In various cases, the quantum computing selection system 102 can facilitate the computer-implemented method 1900.

In various embodiments, act 1902 can include accessing, by a device (e.g., via 118) operatively coupled to a processor, a QML model (e.g., 106).

In various aspects, act 1904 can include identifying, by the device (e.g., via 124) and from a set of quantum computing systems (e.g., 202), a quantum computing system (e.g., 1102) for the quantum machine learning model, based on a comparison between a first coupling map (e.g., one of 204) of the quantum computing system and a second coupling map (e.g., 108) on which the quantum machine learning model was trained.

In various instances, act 1906 can include executing, by the device (e.g., via 126), the quantum machine learning model or an adjusted version of the quantum machine learning model (e.g., one of 802) on the quantum computing system.

Although not explicitly shown in FIG. 19, the first coupling map can be a graph whose nodes respectively represent qubits of the quantum computing system and whose edges respectively represent qubit-to-qubit connections of the quantum computing system, and/or the second coupling map can be a graph whose nodes respectively represent qubits of another quantum computing system on which the quantum machine learning model was trained and whose edges respectively represent qubit-to-qubit connections of the another quantum computing system on which the quantum machine learning model was trained. Furthermore, in various cases, the computer-implemented method 1900 can further include: facilitating, by the device (e.g., via 120), the comparison between the first coupling map and the second coupling map via computation of a subgraph matching metric. In some cases, the subgraph matching metric can be a Gromov-Hausdorff distance or a Manhattan distance between the first coupling map and the second coupling map.

Although not explicitly shown in FIG. 19, the second coupling map can topologically match the first coupling map or can topologically match a subgraph of the first coupling map. In such case, the device can be configured to execute the quantum machine learning model on the quantum computing system.

Although not explicitly shown in FIG. 19, the second coupling map can fail to topologically match the first coupling map and can fail to topologically match every/any subgraph of the first coupling map. In such case, the computer-implemented method 1900 can further include: accessing, by the device (e.g., via 118), a set of variable importance scores (e.g., 110) associated with the quantum machine learning model; and adjusting, by the device (e.g., via 122) and based on the set of variable importance scores, the quantum machine learning model, thereby yielding the adjusted version of the quantum machine learning model. In such case, the device can be configured to execute the adjusted version of the quantum machine learning model on the quantum computing system. Although not explicitly shown in FIG. 19, the computer-implemented method 1900 can further include: determining, by the device (e.g., via 122) and via one or more test runs (e.g., based on 112), an accuracy level (e.g., one of 804) of the adjusted version of the quantum machine learning model.

Accordingly, various embodiments described herein include a computerized tool that can facilitate quantum system selection via coupling map comparison. As described herein, such a computerized tool can be more likely to select/recommend appropriate quantum systems when given a QML model, as compared to existing techniques that rely upon overly-simplistic heuristics or trial-and-error methods. Accordingly, such a computerized tool certainly constitutes a concrete and tangible technical improvement in the field of quantum computing systems.

Although the herein disclosure mainly describes various embodiments of the QML model 106 as being a parametrized quantum circuit, this is a mere non-limiting example for ease of illustration/explanation. In various embodiments, the QML model 106 can exhibit any other suitable quantum artificial intelligence architecture (e.g., can be a quantum neural network).

Although the herein disclosure mainly describes various embodiments as pertaining to quantum computing systems that utilize qubits, this is a mere non-limiting example for ease of explanation. In various embodiments, the herein-described teachings can be applied to any suitable quantum computing systems that include qubits, qutrits, and/or any suitable form of qubits.

Although the herein disclosure mainly describes various embodiments of the map component 120 as comparing the set of coupling maps 204 to the training coupling map 108, this is a mere non-limiting example for ease of illustration/explanation. As mentioned above, the adjustment component 122 can, in various aspects, generate one or more adjusted/relaxed versions of the QML model 106. In some instances, for any given adjusted/relaxed version of the QML model 106, the adjustment component 122 can correspondingly and/or commensurately generate an adjusted/relaxed version of the training coupling map 108. For example, suppose that the adjustment component 122 generates an adjusted/relaxed version of the QML model 106 by copying the QML model 106 and removing/deleting from such copy a particular logical qubit. In such case, the adjustment component 122 can generate an adjusted/relaxed version of the training coupling map 108 by duplicating the training coupling map 108 and removing/deleting/ignoring the one or more physical qubits in that duplicate that correspond to (e.g., that implement) the particular logical qubit. In this way, adjusting/relaxing the QML model 106 can be considered as shrinking the training coupling map 108 (e.g., as shrinking the coupling map to which the set of coupling maps 204 are compared by the map component 120).

Although the herein disclosure mainly describes various embodiments as generating one coupling map similarity score per quantum computing system in the quantum computing system vault 104, this is a mere non-limiting example for ease of illustration/explanation. In various aspects, the map component 120 can generate more than one coupling map similarity score for any given quantum computing system in the quantum computing system vault 104. For example, in some cases, the map component 120 can generate a coupling map similarity score for each subgraph of the coupling map of any given quantum computing system. For instance, consider again the quantum computing system that corresponds to the coupling map 703. In various aspects, a first subgraph given by the qubits 716, 717, 718, 721, and 722 can be considered as topologically matching the coupling map 701. Thus, the coupling map 703 can be considered as having a first similarity score corresponding to that first subgraph. Furthermore, a second subgraph given by the qubits 728, 729, 730, 734, and 735 can also be considered as topologically matching the coupling map 701. So, the coupling map 703 can be considered as having a second similarity score corresponding to that second subgraph. In some cases, that second subgraph can have better coherence times, lower error rates, and/or lower noise levels than the first subgraph. Accordingly, in such cases, the second similarity score can be higher and/or better than the first similarity score. In any case, the map component 120 can, in various aspects, generate more than one similarity score for any given quantum computing system in the quantum computing system vault 104.

Although the herein disclosure mainly describes various embodiments in which the adjustment component 122 generates the set of accuracy levels 804 by actually executing the set of adjusted QML models 802 based on the test data 112, this is a mere non-limiting example. In various embodiments, the adjustment component 122 can refrain from actually executing the set of adjusted QML models 802. Instead, in such cases, the adjustment component 122 can utilize any suitable predictive model (e.g., a classical machine learning model, such as a neural network) to predict/infer the set of accuracy levels 804. In various cases, such predictive model can be trained in any suitable fashion (e.g., supervised training, unsupervised training, reinforcement learning).

The herein disclosure describes non-limiting examples of various embodiments of the subject innovation. For ease of description and/or explanation, various portions of the herein disclosure utilize the term “each” when discussing various embodiments of the subject innovation. Such usages of the term “each” are non-limiting examples. In other words, when the herein disclosure provides a description that is applied to “each” of some particular object and/or component, it should be understood that this is a non-limiting example of various embodiments of the subject innovation, and it should be further understood that, in various other embodiments of the subject innovation, it can be the case that such description applies to fewer than “each” of that particular object and/or component.

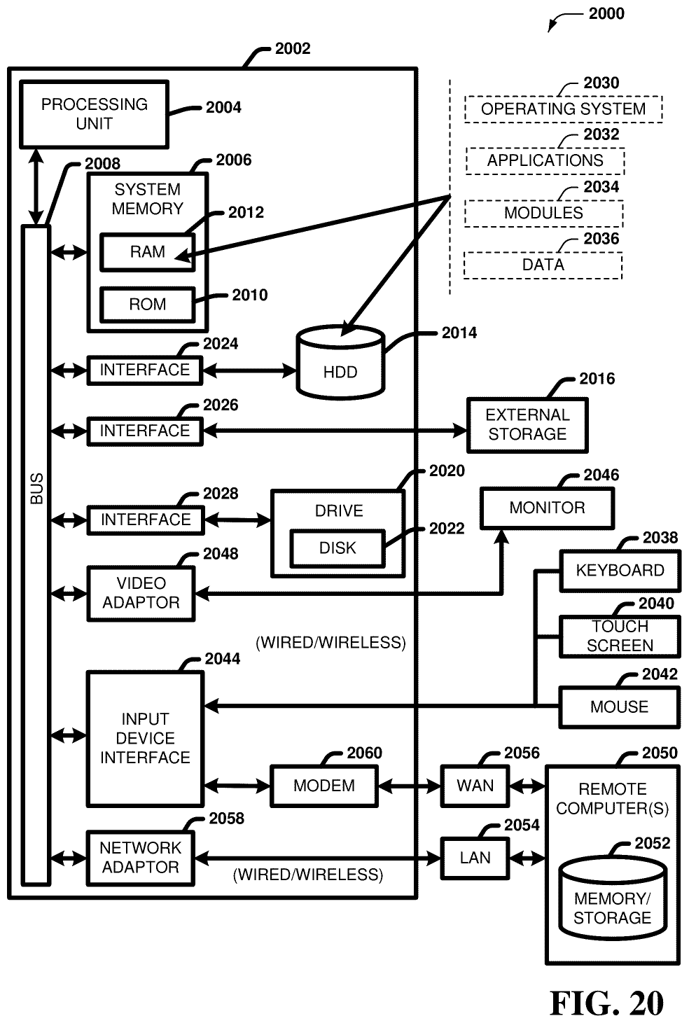

In order to provide additional context for various embodiments described herein, FIG. 20 and the following discussion are intended to provide a brief, general description of a suitable computing environment 2000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 20, the example environment 2000 for implementing various embodiments of the aspects described herein includes a computer 2002, the computer 2002 including a processing unit 2004, a system memory 2006 and a system bus 2008. The system bus 2008 couples system components including, but not limited to, the system memory 2006 to the processing unit 2004. The processing unit 2004 can be any of various commercially available processors. Dual microprocessors and other multi-processor architectures can also be employed as the processing unit 2004.

The system bus 2008 can be any of several types of bus structure that can further interconnect to a memory bus (with or without a memory controller), a peripheral bus, and a local bus using any of a variety of commercially available bus architectures. The system memory 2006 includes ROM 2010 and RAM 2012. A basic input/output system (BIOS) can be stored in a non-volatile memory such as ROM, erasable programmable read only memory (EPROM), EEPROM, which BIOS contains the basic routines that help to transfer information between elements within the computer 2002, such as during startup. The RAM 2012 can also include a high-speed RAM such as static RAM for caching data.

The computer 2002 further includes an internal hard disk drive (HDD) 2014 (e.g., EIDE, SATA), one or more external storage devices 2016 (e.g., a magnetic floppy disk drive (FDD) 2016, a memory stick or flash drive reader, a memory card reader, etc.) and a drive 2020, e.g., such as a solid state drive, an optical disk drive, which can read or write from a disk 2022, such as a CD-ROM disc, a DVD, a BD, etc. Alternatively, where a solid state drive is involved, disk 2022 would not be included, unless separate. While the internal HDD 2014 is illustrated as located within the computer 2002, the internal HDD 2014 can also be configured for external use in a suitable chassis (not shown). Additionally, while not shown in environment 2000, a solid state drive (SSD) could be used in addition to, or in place of, an HDD 2014. The HDD 2014, external storage device(s) 2016 and drive 2020 can be connected to the system bus 2008 by an HDD interface 2024, an external storage interface 2026 and a drive interface 2028, respectively. The interface 2024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2012, including an operating system 2030, one or more application programs 2032, other program modules 2034 and program data 2036. All or portions of the operating system, applications, modules, and/or data can also be cached in the RAM 2012. The systems and methods described herein can be implemented utilizing various commercially available operating systems or combinations of operating systems.

Computer 2002 can optionally comprise emulation technologies. For example, a hypervisor (not shown) or other intermediary can emulate a hardware environment for operating system 2030, and the emulated hardware can optionally be different from the hardware illustrated in FIG. 20. In such an embodiment, operating system 2030 can comprise one virtual machine (VM) of multiple VMs hosted at computer 2002. Furthermore, operating system 2030 can provide runtime environments, such as the Java runtime environment or the .NET framework, for applications 2032. Runtime environments are consistent execution environments that allow applications 2032 to run on any operating system that includes the runtime environment. Similarly, operating system 2030 can support containers, and applications 2032 can be in the form of containers, which are lightweight, standalone, executable packages of software that include, e.g., code, runtime, system tools, system libraries and settings for an application.

Further, computer 2002 can be enable with a security module, such as a trusted processing module (TPM). For instance with a TPM, boot components hash next in time boot components, and wait for a match of results to secured values, before loading a next boot component. This process can take place at any layer in the code execution stack of computer 2002, e.g., applied at the application execution level or at the operating system (OS) kernel level, thereby enabling security at any level of code execution.

A user can enter commands and information into the computer 2002 through one or more wired/wireless input devices, e.g., a keyboard 2038, a touch screen 2040, and a pointing device, such as a mouse 2042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2004 through an input device interface 2044 that can be coupled to the system bus 2008, but can be connected by other interfaces, such as a parallel port, an IEEE 1394 serial port, a game port, a USB port, an IR interface, a BLUETOOTH® interface, etc.

A monitor 2046 or other type of display device can be also connected to the system bus 2008 via an interface, such as a video adapter 2048. In addition to the monitor 2046, a computer typically includes other peripheral output devices (not shown), such as speakers, printers, etc.

The computer 2002 can operate in a networked environment using logical connections via wired and/or wireless communications to one or more remote computers, such as a remote computer(s) 2050. The remote computer(s) 2050 can be a workstation, a server computer, a router, a personal computer, portable computer, microprocessor-based entertainment appliance, a peer device or other common network node, and typically includes many or all of the elements described relative to the computer 2002, although, for purposes of brevity, only a memory/storage device 2052 is illustrated. The logical connections depicted include wired/wireless connectivity to a local area network (LAN) 2054 and/or larger networks, e.g., a wide area network (WAN) 2056. Such LAN and WAN networking environments are commonplace in offices and companies, and facilitate enterprise-wide computer networks, such as intranets, all of which can connect to a global communications network, e.g., the Internet.

When used in a LAN networking environment, the computer 2002 can be connected to the local network 2054 through a wired and/or wireless communication network interface or adapter 2058. The adapter 2058 can facilitate wired or wireless communication to the LAN 2054, which can also include a wireless access point (AP) disposed thereon for communicating with the adapter 2058 in a wireless mode.

When used in a WAN networking environment, the computer 2002 can include a modem 2060 or can be connected to a communications server on the WAN 2056 via other means for establishing communications over the WAN 2056, such as by way of the Internet. The modem 2060, which can be internal or external and a wired or wireless device, can be connected to the system bus 2008 via the input device interface 2044. In a networked environment, program modules depicted relative to the computer 2002 or portions thereof, can be stored in the remote memory/storage device 2052. It will be appreciated that the network connections shown are example and other means of establishing a communications link between the computers can be used.

When used in either a LAN or WAN networking environment, the computer 2002 can access cloud storage systems or other network-based storage systems in addition to, or in place of, external storage devices 2016 as described above, such as but not limited to a network virtual machine providing one or more aspects of storage or processing of information. Generally, a connection between the computer 2002 and a cloud storage system can be established over a LAN 2054 or WAN 2056 e.g., by the adapter 2058 or modem 2060, respectively. Upon connecting the computer 2002 to an associated cloud storage system, the external storage interface 2026 can, with the aid of the adapter 2058 and/or modem 2060, manage storage provided by the cloud storage system as it would other types of external storage. For instance, the external storage interface 2026 can be configured to provide access to cloud storage sources as if those sources were physically connected to the computer 2002.

The computer 2002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

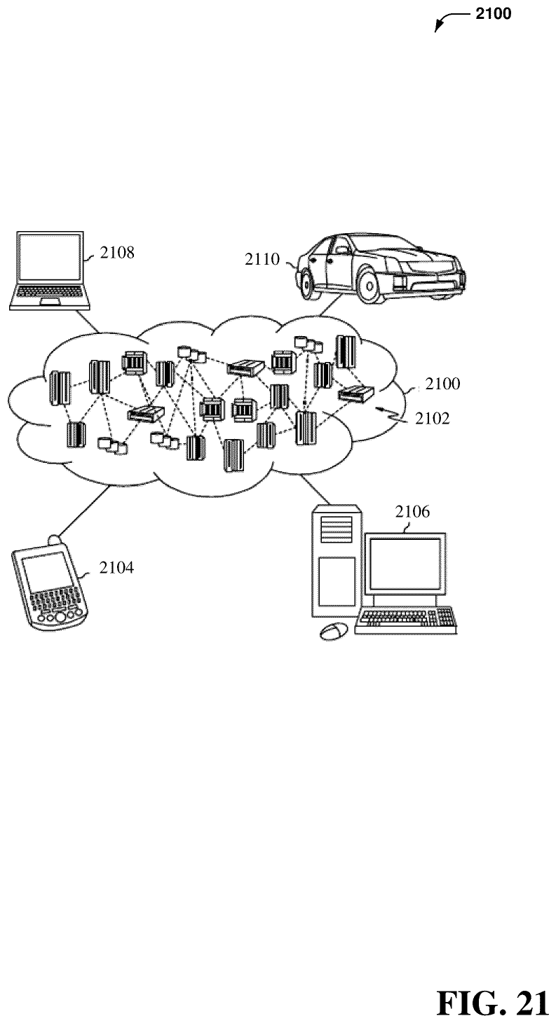

Referring now to FIG. 21, illustrative cloud computing environment 2100 is depicted. As shown, cloud computing environment 2100 includes one or more cloud computing nodes 2102 with which local computing devices used by cloud consumers, such as, for example, personal digital assistant (PDA) or cellular telephone 2104, desktop computer 2106, laptop computer 2108, and/or automobile computer system 2110 may communicate. Nodes 2102 may communicate with one another. They may be grouped (not shown) physically or virtually, in one or more networks, such as Private, Community, Public, or Hybrid clouds as described hereinabove, or a combination thereof. This allows cloud computing environment 2100 to offer infrastructure, platforms and/or software as services for which a cloud consumer does not need to maintain resources on a local computing device. It is understood that the types of computing devices 2104-2110 shown in FIG. 21 are intended to be illustrative only and that computing nodes 2102 and cloud computing environment 2100 can communicate with any type of computerized device over any type of network and/or network addressable connection (e.g., using a web browser).

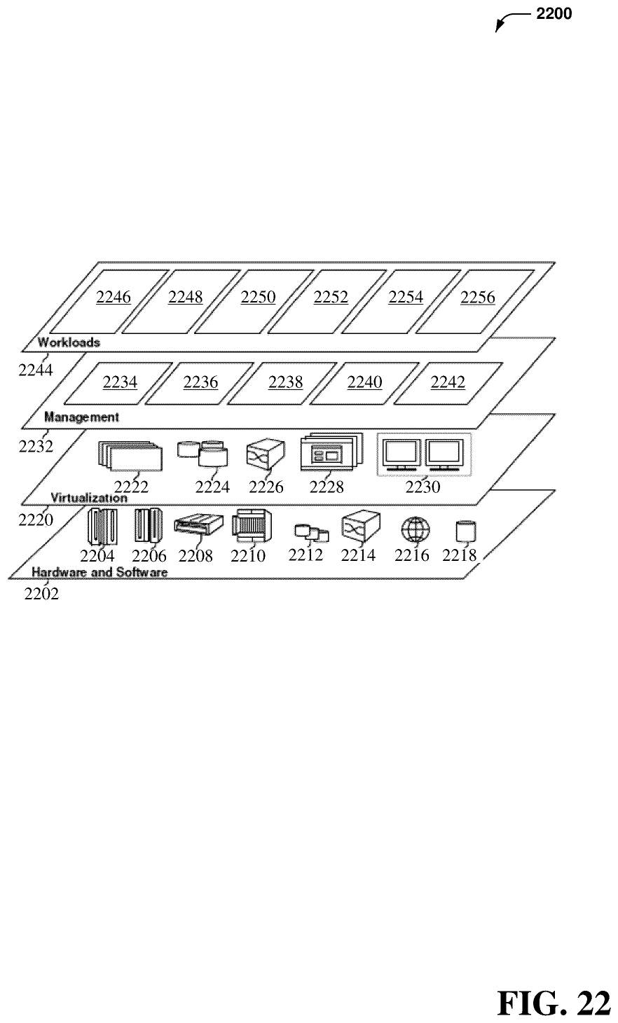

Referring now to FIG. 22, a set of functional abstraction layers provided by cloud computing environment 2100 (FIG. 21) is shown. Repetitive description of like elements employed in other embodiments described herein is omitted for sake of brevity. It should be understood in advance that the components, layers, and functions shown in FIG. 22 are intended to be illustrative only and embodiments described herein are not limited thereto. As depicted, the following layers and corresponding functions are provided.

Hardware and software layer 2202 includes hardware and software components. Examples of hardware components include: mainframes 2204; RISC (Reduced Instruction Set Computer) architecture based servers 2206; servers 2208; blade servers 2210; storage devices 2212; and networks and networking components 2214. In some embodiments, software components include network application server software 2216 and database software 2218.

Virtualization layer 2220 provides an abstraction layer from which the following examples of virtual entities may be provided: virtual servers 2222; virtual storage 2224; virtual networks 2226, including virtual private networks; virtual applications and operating systems 2228; and virtual clients 2230.

In one example, management layer 2232 may provide the functions described below. Resource provisioning 2234 provides dynamic procurement of computing resources and other resources that are utilized to perform tasks within the cloud computing environment. Metering and Pricing 2236 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2238 provides access to the cloud computing environment for consumers and system administrators. Service level management 2240 provides cloud computing resource allocation and management such that required service levels are met. Service Level Agreement (SLA) planning and fulfillment 2242 provide pre-arrangement for, and procurement of, cloud computing resources for which a future requirement is anticipated in accordance with an SLA.

Workloads layer 2244 provides examples of functionality for which the cloud computing environment may be utilized. Examples of workloads and functions which may be provided from this layer include: mapping and navigation 2246; software development and lifecycle management 2248; virtual classroom education delivery 2250; data analytics processing 2252; transaction processing 2254; and differentially private federated learning processing 2256. Various embodiments described herein can utilize the cloud computing environment described with reference to FIGS. 21 and 22 to execute one or more differentially private federated learning process in accordance with various embodiments described herein.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, and/or data structures, that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
at least one processor that executes computer-executable components stored in at least one non-transitory computer-readable memory, wherein the computer-executable components comprise:
an access component that is configured to access a quantum machine learning model;
a selection component that is configured to identify, from a set of quantum computing systems, a quantum computing system for the quantum machine learning model, based on a comparison between a first coupling map of the quantum computing system and a second coupling map on which the quantum machine learning model was trained; and
an execution component that is configured to execute the quantum machine learning model or an adjusted version of the quantum machine learning model on the quantum computing system.

2. The system of claim 1, wherein the first coupling map is a graph whose nodes respectively represent qubits of the quantum computing system and whose edges respectively represent qubit-to-qubit connections of the quantum computing system, wherein the second coupling map is a graph whose nodes respectively represent qubits of another quantum computing system on which the quantum machine learning model was trained and whose edges respectively represent qubit-to-qubit connections of the another quantum computing system on which the quantum machine learning model was trained, and wherein the computer-executable components further comprise:
a map component that is configured to compare the first coupling map to the second coupling map by computing a subgraph matching metric.

3. The system of claim 2, wherein the subgraph matching metric is a Gromov-Hausdorff distance or a Manhattan distance between the first coupling map and the second coupling map.

4. The system of claim 2, wherein the second coupling map topologically matches the first coupling map or topologically matches a subgraph of the first coupling map, and wherein the execution component is configured to execute the quantum machine learning model on the quantum computing system.

5. The system of claim 2, wherein the second coupling map does not topologically match the first coupling map and does not topologically match any subgraph of the first coupling map, wherein the access component is further configured to access a set of variable importance scores associated with the quantum machine learning model, and wherein the computer-executable components further comprise:
an adjustment component that is configured to adjust, based on the set of variable importance scores, the quantum machine learning model, thereby yielding the adjusted version of the quantum machine learning model, wherein the execution component is configured to execute the adjusted version of the quantum machine learning model on the quantum computing system.

6. The system of claim 5, wherein the adjustment component is configured to determine, by one or more test runs, an accuracy level of the adjusted version of the quantum machine learning model.

7. The system of claim 5, wherein the adjustment component is configured to adjust the quantum machine learning model by iteratively removing, in order of increasing variable importance score, at least one logical qubit or at least one quantum gate from the quantum machine learning model.

8. The system of claim 5, wherein the map component and the adjustment component are configured to prioritize analysis of the set of quantum computing systems according to system availability, qubit count, noise levels, or coherence times.

9. A computer-implemented method, comprising:
accessing, by a device operatively coupled to at least one processor, a quantum machine learning model;
identifying, by the device and from a set of quantum computing systems, a quantum computing system for the quantum machine learning model, based on a comparison between a first coupling map of the quantum computing system and a second coupling map on which the quantum machine learning model was trained; and
executing, by the device, the quantum machine learning model or an adjusted version of the quantum machine learning model on the quantum computing system.

10. The computer-implemented method of claim 9, wherein the first coupling map is a graph whose nodes respectively represent qubits of the quantum computing system and whose edges respectively represent qubit-to-qubit connections of the quantum computing system, wherein the second coupling map is a graph whose nodes respectively represent qubits of another quantum computing system on which the quantum machine learning model was trained and whose edges respectively represent qubit-to-qubit connections of the another quantum computing system on which the quantum machine learning model was trained, and further comprising:
facilitating, by the device, the comparison between the first coupling map and the second coupling map by computing a subgraph matching metric.

11. The computer-implemented method of claim 10, wherein the subgraph matching metric is a Gromov-Hausdorff distance or a Manhattan distance between the first coupling map and the second coupling map.

12. The computer-implemented method of claim 10, wherein the second coupling map topologically matches the first coupling map or topologically matches a subgraph of the first coupling map, and wherein the device is configured to execute the quantum machine learning model on the quantum computing system.

13. The computer-implemented method of claim 10, wherein the second coupling map does not topologically match the first coupling map and does not topologically match any subgraph of the first coupling map, and further comprising:
accessing, by the device, a set of variable importance scores associated with the quantum machine learning model; and
adjusting, by the device and based on the set of variable importance scores, the quantum machine learning model, thereby yielding the adjusted version of the quantum machine learning model, wherein the device is configured to execute the adjusted version of the quantum machine learning model on the quantum computing system.

14. The computer-implemented method of claim 13, further comprising:
determining, by the device and via one or more test runs, an accuracy level of the adjusted version of the quantum machine learning model.

15. The computer-implemented method of claim 13, wherein the adjusting the quantum machine learning model includes iteratively removing, by the device and in order of increasing variable importance score, at least one logical qubit or at least one quantum gate from the quantum machine learning model.

16. The computer-implemented method of claim 13, wherein the device prioritizes analysis of the set of quantum computing systems according to system availability, qubit count, noise levels, or coherence times.

17. A computer program product for facilitating quantum system selection via coupling map comparison, the computer program product comprising at least one non-transitory computer-readable memory having program instructions embodied therewith, the program instructions executable by at least one processor to cause the at least one processor to:
access a quantum machine learning model and a set of variable importance scores associated with the quantum machine learning model;
identify, from a set of quantum computing systems, a quantum computing system for the quantum machine learning model, wherein a first coupling map of the quantum computing system does not topologically match a second coupling map on which the quantum machine learning model was trained, and wherein no subgraph of the first coupling map topologically matches the second coupling map on which the quantum machine learning model was trained;
adjust, based on the set of variable importance scores, the quantum machine learning model, thereby yielding an adjusted version of the quantum machine learning model; and
execute the adjusted version of the quantum machine learning model on the quantum computing system.

18. The computer program product of claim 17, wherein the at least one processor is configured to adjust the quantum machine learning model by iteratively removing, in order of increasing variable importance score, at least one logical qubit or at least one quantum gate from the quantum machine learning model.

19. The computer program product of claim 17, wherein the at least one processor is configured to adjust the quantum machine learning model by iteratively removing, in random order, at least one logical qubit or at least one quantum gate from the quantum machine learning model.

20. The computer program product of claim 17, wherein the set of variable importance scores are based on univariate Fisher scores of the quantum machine learning model or local scope Shapley values of the quantum machine learning model.
